(19) United States
(12) Patent Application Publication
(10) Pub. No.: US 2023/0246946 A1
(43) Pub. Date: Aug. 3, 2023

(54) METHODS AND SYSTEMS FOR MULTICAST COMMUNICATION SESSION MANAGEMENT

(71) Applicant: Comcast Cable Communications, LLC, Philadelphia, PA (US)

(72) Inventors: Yiu LEE, Philadelphia, PA (US); Bin WEN, Philadelphia, PA (US); Mannarmannan VENKATESAN, Philadelphia, PA (US)

(21) Appl. No.: 17/587,627

(22) Filed: Jan. 28, 2022

(51) Int. Cl. H04L 45/16; H04L 45/302; H04L 65/611; H04L 65/65

(52) U.S. Cl. CPC H04L 45/16; H04L 45/302; H04L 65/4076; H04L 65/608

(57) ABSTRACT

A computing device may receive a request to join a multicast of content. The request may comprise a user device identifier associated with the user device. The computer device may receive a second request to leave the multicast of the content. The second request may comprise the user device identifier. The computing device may determine a quantity of data received by the user device from the multicast of the content. The computing device may determine the quantity of data received based on the request and the second request. The computing device may apply the quantity of data to an account associated with the user device.

### BACKGROUND

Distribution of content can occur in a number of ways. One method for distributing content is through the use of multicast transmission. Multicast transmission of content may optimize network use by reducing the number of packets of the content that are replicated. Instead of replicating the packets of the content from the content source and through each network device until ultimately being passed to a user device, which occurs in unicast transmissions, in multicast transmissions, the packets of the content are only replicated at the last edge device (e.g., local multicast router) for distribution to the user devices requesting the content. However, unlike unicast transmissions, the packets sent by way of multicast transmission do not contain information that identifies the user device or devices that will receive the content. Not being able to determine from the multicast packet itself which user devices are receiving a multicast of the content may make it difficult to evaluate content quality issues related to the content or determine the quantity of data a user device is receiving by way of the multicast of the content.

### SUMMARY

It is to be understood that both the following general description and the following detailed description are exemplary and explanatory only and are not restrictive. Methods and systems for managing multicast communication sessions are described.

A network device, such as a local multicast router, may receive a join request from a user device for the user device to receive a multicast of content. The network device may determine the content source in the request, remove any user device identifier information from the join request, and send the join request to another multicast router (e.g., a remote or regional multicast router). The network device may also generate a join message that includes the user device identifier information and a timestamp indicating a start time for receiving the multicast of the content. The network device may send the join message to a multicast flow analyzer computing device. The multicast of the content may be received by the network device and sent to the requesting user device. The multicast of the content may also pass through the multicast flow analyzer computing device.

The network device may subsequently receive a leave request from the user device for the user device to stop receiving the multicast of the content. The network device may remove any user device identifier information from the leave request and send the leave request to the other multicast router. The network device may generate a leave message that includes the user device identifier information and a timestamp indicating an end time for the user device no longer receiving the multicast of the content. The network device may send that leave message to the multicast flow analyzer computing device. The multicast flow analyzer computing device may determine the quantity of data that the user device received during the multicast of the content based on information associated with the multicast of the content and information in the join message and the leave message.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the apparatuses and systems described herein:

FIG. 1 shows an example system for managing a multicast communication session;

FIG. 2 shows an example communication diagram for managing a multicast communication session;

FIG. 3A-B show an example system for managing a multicast communication session;

FIG. 4 shows a flowchart of an example method for managing a multicast communication session;

FIG. 5 shows a flowchart of another example method for managing a multicast communication session;

FIG. 6 shows a flowchart of another example method for managing a multicast communication session;

FIG. 7 shows a flowchart of another example method for managing a multicast communication session;

FIG. 8 shows a flowchart of another example method for managing a multicast communication session;

FIG. 9 shows a flowchart of another example method for managing a multicast communication session; and

FIG. 10 shows a block diagram of an example computing device for implementing management of a multicast communication session.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

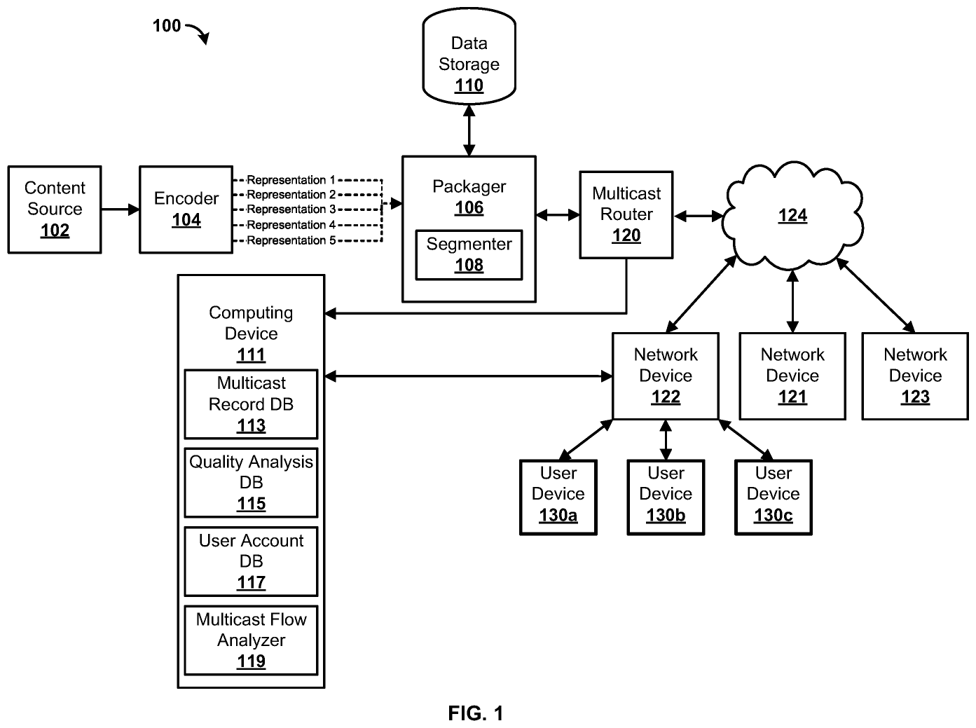

FIG. 1 shows an example system 100. The example system 100 may be configured for managing a communication session (e.g., a multicast communication session). Although only certain devices and/or components are shown, the system 100 may comprise a variety of other devices and/or components that support a wide variety of network and/or communication functions, operations, protocols, content, services, and/or the like. The system 100 may comprise a plurality of computing devices/entities in communication via a network 124. The network 124 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent on the network 124 via a variety of transmission paths, including wireless paths (e.g., satellite paths, Wi-Fi paths, cellular paths, etc.) and terrestrial paths (e.g., wired paths, a direct feed source via a direct line, etc.). The network 124 may comprise public networks, private networks, wide area networks (e.g., Internet), local area networks, and/or the like. The network 124 may comprise a content access network, content distribution network, and/or the like. The network 124 may be configured to provide content from a variety of sources using a variety of network paths, protocols, devices, and/or the like. The content delivery network and/or content access network may be managed (e.g., deployed, serviced) by, for example, a content provider, a service provider, and/or the like. The network 124 may deliver content items from a content source 102 (e.g., a multicast content source) to one or more other computing devices (e.g., user devices 130a-c).

The system 100 may comprise the one or more content sources 102, each of which may be a server or other computing device. The content source 102 may receive source streams for a plurality of content items. The source streams may be video content, audio content, web-based content, and/or audio/video content. The source streams may be live streams (e.g., a linear content stream) audio-on-demand streams, and/or video-on-demand (VOD) streams. The content source 102 may receive source streams from an external server or device (e.g., a stream capture source, a data storage device, a media server, etc.). The content source 102 may receive the source streams via a wired or a wireless network connection, such as the network 124 or another network (not shown). For example, the content source 102 may be a multicast content source configured to send or otherwise transmit content via a multicast transmission.

The content source 102 may be managed by a third-party, such as content providers, service providers, online content providers, over-the-top content providers, and/or the like. The content source 102 may be configured to provide content items via the network 124. Content items may be accessed by one or more second user devices 130a-c via applications, such as mobile applications, television applications, set-top box applications, gaming device applications, and/or the like. An application may be a custom application (e.g., by a content provider, for a specific device), a general content browser (e.g., a web browser), an electronic program guide, and/or the like.

Although one content source 102 is shown in FIG. 1, this is not to be considered limiting. In accordance with the described techniques, the system 100 may comprise any number of content sources, each of which may receive any number of source streams.

The system 100 may comprise one or more encoders 104, such as a video encoder, an audio encoder a content encoder, etc. The encoder 104 may be configured to encode one or more source streams (e.g., received via the content source 102 or another computing device) into a plurality of content items/streams at various bitrates (e.g., various representations). For example, the encoder 104 may be configured to encode the source stream for a content item at varying bitrates for corresponding representations (e.g., versions, such as Representations 1-5) of a content item for adaptive bitrate streaming. It is to be understood that FIG. 1 shows five representations for explanation purposes only, as the encoder 104 may be configured to encode the source stream into fewer or greater representations.

The system 100 may comprise a packager 106. The packager 106 may be configured to receive one or more content items/streams from the encoder 104 or any other computer device. The packager 106 may be configured to prepare content items/streams for distribution. For example, the packager 106 may be configured to convert encoded content items/streams into a plurality of content fragments. For example, the packager 106 may comprise a segmenter 108. The packager 106 may also comprise (or have access to) a data storage device 110. The segmenter 108 may divide a set of encoded streams into media/content segments. For example, the segmenter 108 may process the incoming encoded streams of content and break the encoded streams of content into segments at key frame boundaries at or near particular time periods apart or data allotments. Further, if the encoded streams include separate video and audio streams, the segmenter 108 may generate the segments such that the video and audio streams are timecode aligned. Segments may alternately be referred to as “chunks.”

The packager 106 may be configured to support both multiplexed segments (video and audio data included in a single multiplexed stream) and non-multiplexed segments (video and audio data included in separate non-multiplexed streams). Further, in the case of MPEG-DASH, the packager 106 may be configured to support container formats in compliance with international standards organization base media file format (ISOBMFF), associated with a file extension “.m4s”), motion picture experts group 2 transport stream (MPEG-TS), extensible binary markup language (EBML), WebM, Matroska, or any combination thereof.

The packager 106 may be configured to provide content items/streams according to adaptive bitrate streaming. For example, the packager 106 may be configured to convert encoded content items/streams at various representations into one or more adaptive bitrate streaming formats, such as Apple HTTP Live Streaming (HLS), Microsoft Smooth Streaming, Adobe HTTP Dynamic Streaming (HDS), MPEG DASH, and/or the like. The packager 106 may pre-package content items/streams and/or provide packaging in real-time as content items/streams are requested by user devices, such as the user devices 130a-c.

The system 100 may also comprise a multicast router 120. For example, the multicast router 120 may be a regional or remote multicast router. The multicast router 120 may be configured to send or otherwise transmit data packets comprising segments of a requested content item to one or more network devices 121-123 (e.g., local multicast routers) and to the computing device 111 (e.g., the quality analysis database 115) for evaluation of the quality of the requested content by the multicast flow analyzer 119 for all or any portion of the requested content. For example, the multicast router 120 may be configured to receive requests (e.g., join requests and leave requests) from local multicast routers or other network devices (e.g., network devices 121-123). For example, the requests may be an internet group management protocol (IGMP) request sent via internet protocol version 4 (IPv4) or may be a multicast listener discovery (MLD) request sent via internet protocol version 6 (IPv6). For a join request, the multicast router 120 may determine the content source and/or the content item being requested and determine if the content source (e.g., content source 102) providing the requested content is within a content distribution map associated with (e.g., stored within) the multicast router 120. If the content source 102 is within the content distribution map for the multicast router 120, the multicast router 120 may receive data packets of the content from the content source 102 or a packager 106 associated with the content source 102 and distribute the data packets for the requested content to the computing device 111 (e.g., the multicast flow analyzer 119) and one or more of the network devices 121-123 for subsequent distribution to the user device 130a-c requesting the content. The multicast router 120 may also send data or information associated with the requested content to the computing device 111. The data or information associated with the requested content may comprise the multicast source identifier, the multicast group identifier, timing information associated with the requested content (e.g., a timestamp), data rate information (e.g., bit rate or quantity of data within each packet or group of packets) associated with the requested content, and/or packet number information associated with the requested content.

The system 100 may also comprise one or more network devices 121-123. The one or more network devices 121-123 may be any one of a router, a gateway, an edge device, an access point or other common network node. For example, the one or more network devices 121-123 may be multicast routers (e.g., local multicast routers). The network devices 121-123 may be configured to receive requests (e.g., join requests and leave requests) from a user device (e.g., user devices 130a-c). For example, the requests may be an IGMP request sent via IPv4 or may be a MLD request sent via IPv6. For a join request, the network device 121-123 may determine the content source and/or the content item being requested and determine if the content source (e.g., content source 102) providing the requested content is within a content distribution map associated with (e.g., stored within) the network device 121-123. If the content source 102 is within the content distribution map for the network device 121-123, the network device 121-123 may configure itself to forward data packets associated with the content in the join request to a user device 130a-c. For example, the network device 121-123 may identify the port used for communication with particular user device 130a-c from which the join request is received and then storing information associated with the received join request in memory. For example, the stored information may comprise the user device identifier, the multicast source identifier, the multicast group identifier, and/or a port identifier used for communicating with the particular user device 130a-c. The network device 121-123 may also communicate all or a portion of the information in the request to the multicast router 120 (e.g., a regional or remote multicast router). Similar operations may occur for leave requests received by the network device 121-123 from one of the user devices 130a-c. The network device 121-123 may receive data packets of the content from the content source 102 or multicast router 120, determine which user devices 130a-c requested to receive the content, and distribute the data packets for the requested content to one or more of the user devices 130a-c.

The network device 121-123 may also send data or information associated with requests received form user devices 130a-c to the computing device 111. The data or information may be in the form of a message and comprise the user device identifier, the multicast source identifier, the multicast group identifier, and/or timing information (e.g., a timestamp) associated with the request.

The system 100 may comprise a computing device 111. For example, the computing device 111 may be or comprise a content server. For example, the computing device 111 may be configured to receive and/or evaluate data packets of the requested content and data or information associated with requests related to the content. For example, the requests may be associated with one or more multicasts of content. For example, the requests may be to join or leave a multicast of content.

The computing device 111 may comprise a multicast records database 113. The multicast records database 113 may be any form of database or memory storage and may be within or communicably coupled to the computing device 111. The multicast records database 113 may comprise data record entries or tables of data associated with multicasts of content and/or requests associated with multicasts of content. For example, the multicast records database 113 may comprise data record entries or tables comprising information associated with individual requests by user devices (e.g., user devices 130a-c) to receive and/or leave a multicast of content. For example, the information may comprise any one or more of a user device identifier, a multicast source identifier, a multicast group identifier, a join time associated with a time the user device 130a-c begins to receive the multicast of the content, a leave time associated with a time the user device 130a-c leaves or no longer continues to receive the multicast of the content, a packet count associated with the number of packets of the multicast of the content determined to be received by the user device 130a-c, and/or a data amount associated with the quantity of data received by the user device 130a-c while receiving the multicast of the content. For example, the multicast records database 113 may comprise data record entries or tables comprising information associated with multicasts of content. For example, the information associated with multicasts of content may comprise one or more of the multicast source identifier, the multicast group identifier, one or more bit rates for the multicast of the content, time entries associated with the sending of the multicast of the content, packet identifiers or numbers associated with particular time entries, data amounts associated with particular time entries, and/or time periods for quality issues associated with the multicast of the content.

The computing device 111 may comprise a quality analysis database 115. The quality analysis database 115 may be any form of database or memory storage and may be within or communicably coupled to the computing device 111. The quality analysis database 113 may comprise all or portions of the multicast of the content. The quality analysis database 113 may comprise data record entries or tables of data associated with quality control issues associated with the distribution of content (e.g., the multicast of the content). For example, the quality control issues may comprise one or more of jitter, latency, packet drop, packet re-transmit rate, video bitrate variance, and/or out-of-order real-time transport protocol (RTP) packet count associated with any one or more multicasts of the content. For example, the data within the data record entries or tables may comprise one or more of the type of quality control issue, timing information (e.g., time stamp of the content or first packet of the content being evaluated, start and stop times of the evaluation period for the content being evaluated) of the quality control issue, the multicast source identifier, the multicast group identifier, and/or the one or more user device identifiers associated with user devices 130a-c receiving the multicast of the particular content during the time period associated with the timing information, and/or experiencing quality issues related to the multicast of the particular content.

The computing device 111 may comprise a user account database 117. The user account database 117 may be any form of database or memory storage and may be within or communicably coupled to the computing device 111. The user account database 113 may comprise data record entries or tables of data associated with user or customer accounts. For example, the data within the data record entries or tables may comprise account information for a plurality of users and may comprise one or more of user name, user address, user phone number, user device identifier(s), historical account information, billing information, and/or the quantity of data received by the user devices associated with the user identified by each particular user account. While the computing device 111 is shown to have the multicast records database 113, the quality analysis database 115, and the user account database 117, this is for example purposes only, as the information associated with each database may be combined into a single database or divided in any manner between any number of databases.

The computing device 111 may comprise a multicast flow analyzer 119. The multicast flow analyzer 119 may be configured to receive the multicast of content from the multicast router 120 and other data from the multicast router 120 and the network devices 121-123 via the network 124 or another network. For example, the multicast flow analyzer 119 may be configured to receive data associated with multicast leave requests and multicast join requests from the network devices 121-123. The data associated with the multicast leave and/or join requests may comprise one or more of user device identifiers, multicast source identifiers, multicast group identifiers, start times associated with when a particular user device 130a-c begins to receive the content, and/or leave times associated with when a particular user device 130a-c stops receiving, or leaves, a multicast of the content.

For example, the multicast flow analyzer 119 may be configured to receive data associated with the multicast of the content from the multicast router 120. For example, the data associated with the multicast of the content may comprise any one or more of the multicast source identifier, the multicast group identifier, one or more bit rates for the multicast of the content, time entries associated with the sending of the multicast of the content, packet identifiers or numbers of the content associated with particular time entries, data amounts associated with particular time entries, and/or time periods for quality issues associated with the multicast of the content.

The multicast flow analyzer 119 may be configured to determine a quantity of data received by a particular user device 130a-c for a particular multicast of the content. The multicast flow analyzer may determine the amount of the data received based on information in the multicast record database 113. The multicast flow analyzer may be configured to apply the quantity of data received by the particular user device 130a-c to a user account associated with the user of the particular user device 130a-c in the user account database 117.

The multicast flow analyzer 119 may be configured to determine quality control issues related to the multicast of the content. For example, the quality control issues may be one or more of jitter, latency, packet drop, packet re-transmit rate, video bitrate variance, and/or out-of-order RTP packet count for the multicast of the content. For example, the multicast flow analyzer 119 may receive a portion of the content in the multicast of the content. The multicast flow analyzer 119 may sample the packets of the multicast of the content over a time period and conduct quality control analysis on the packets to evaluate the quality control issues (e.g., jitter, latency, packet drop, packet re-transmit rate, video bitrate variance, and/or out-of-order RTP packet count) within the sample of packets during that time period. The time period can be any amount of time and may be configurable or a set amount of time. For example, the time period may be five seconds. For example, the multicast flow analyzer 119 may sample multiple packets during the time period and evaluate the quality control issues at each packet and any trends for any of the quality control issues as the time passes during that time period.

For example, the multicast flow analyzer 119 may determine that at TO of the content jitter is 20 milliseconds (ms); at T1 jitter is 40 ms; and at T2 jitter is 60 ms. For example, the multicast flow analyzer 119 may determine that any jitter in the multicast of content over 0 ms or another jitter threshold signifies a quality issue related to jitter for the multicast of the content. For example, the multicast flow analyzer 119 may determine that a trending increase in jitter over two or more of the time samples signifies a quality issue related to jitter for the multicast of the content. The multicast flow analyzer 119 may store data associated with the quality issue in the quality analysis database 115. For example, the data may include the type of quality issue (e.g., jitter), the values of jitter determined, and/or the time or time period of the samples evaluated from the multicast of the content that were determined to identify the quality issue.

For example, the multicast flow analyzer 119 may determine that at TO of the content latency is 50 milliseconds (ms); at T1 latency is 150 ms; and at T2 latency is 200 ms. For example, the multicast flow analyzer 119 may determine that any latency in the multicast of content over 0 ms or another latency threshold signifies a quality issue related to latency for the multicast of the content. For example, the multicast flow analyzer 119 may determine that a trending increase in latency over two or more of the time samples signifies a quality issue related to latency for the multicast of the content. The multicast flow analyzer 119 may store data associated with the quality issue in the quality analysis database 115. For example, the data may include the type of quality issue (e.g., latency), the values of latency determined, and/or the time or time period of the samples evaluated from the multicast of the content that were determined to identify the quality issue.

For example, the multicast flow analyzer 119 may determine that at TO of the content packet drop is 0%; at T1 packet drop is 0.5%; and at T2 packet drop is 1%. For example, the multicast flow analyzer 119 may determine that any packet drop in the multicast of content over 0% or another packet drop threshold signifies a quality issue related to packet drop for the multicast of the content. For example, the multicast flow analyzer 119 may determine that a trending increase in packet drops over two or more of the time samples signifies a quality issue related to packet drop for the multicast of the content. The multicast flow analyzer 119 may store data associated with the quality issue in the quality analysis database 115. For example, the data may include the type of quality issue (e.g., packet drop), the values of packet drop determined, and/or the time or time period of the samples evaluated from the multicast of the content that were determined to identify the quality issue.

For example, the multicast flow analyzer 119 may determine that at TO of the content packet re-transmit rate is 0%; at T1 packet re-transmit rate is 0.5%; and at T2 packet re-transmit rate is 1%. For example, the multicast flow analyzer 119 may determine that any packet re-transmit rate in the multicast of content over 0% or another packet re-transmit rate threshold signifies a quality issue related to packet re-transmit rate for the multicast of the content. For example, the multicast flow analyzer 119 may determine that a trending increase in packet re-transmit rate over two or more of the time samples signifies a quality issue related to packet re-transmit rate for the multicast of the content. The multicast flow analyzer 119 may store data associated with the quality issue in the quality analysis database 115. For example, the data may include the type of quality issue (e.g., packet re-transmit rate), the values of packet re-transmit rate determined, and/or the time or time period of the samples evaluated from the multicast of the content that were determined to identify the quality issue.

For example, the multicast flow analyzer 119 may determine that at TO of the content out-of-order RTP packet count is 0; at T1 out-of-order RTP packet count is 1; and at T2 out-of-order RTP packet count is 2. For example, the multicast flow analyzer 119 may determine that any out-of-order RTP packet count in the multicast of content over 0 or another out-of-order RTP packet count threshold signifies a quality issue related to out-of-order RTP packet count for the multicast of the content. For example, the multicast flow analyzer 119 may determine that a trending increase in out-of-order RTP packet count over two or more of the time samples signifies a quality issue related to out-of-order RTP packet count for the multicast of the content. The multicast flow analyzer 119 may store data associated with the quality issue in the quality analysis database 115. For example, the data may include the type of quality issue (e.g., out-of-order RTP packet count), the values of out-of-order RTP packet count determined, and/or the time or time period of the samples evaluated from the multicast of the content that were determined to identify the quality issue.

The multicast flow analyzer 119 may determine the bitrate of packets based on an analysis of the MPEG header for the packet. For example, the multicast flow analyzer 119 may determine that at TO of the content the bitrate may be 1900 kbps; at T1 the bitrate is 1200 kbps; and at T2 the bitrate is 900 kbps. For example, the multicast flow analyzer 119 may determine that any bitrate in the multicast of content that represents less that a high-definition distribution of the multicast of the content (e.g., less than or less than or equal to 1200 kbps) or another specific bitrate threshold signifies a quality issue related to bitrate for the multicast of the content. For example, the multicast flow analyzer 119 may determine that a trending decrease in bitrate over two or more of the time samples signifies a quality issue related to bitrate for the multicast of the content. The multicast flow analyzer 119 may store data associated with the quality issue in the quality analysis database 115. For example, the data may include the type of quality issue (e.g., bitrate variance), the values of bitrates determined, and/or the time or time period of the samples evaluated from the multicast of the content that were determined to identify the quality issue.

For multicasts of content where quality issues are identified, the multicast flow analyzer 119 may cause the receipt of the multicast of the content by the user devices 130a-c to change from the current content source 102 to a different content source. For example, the multicast flow analyzer 119 may evaluate timing data associated with one or more user devices 130a-c receiving the multicast of the content to determine if the particular user device 130a-c was receiving the multicast of the content during the time or time period during which the quality issue was identified in the multicast of the content.

The system 100 may comprise one or more user devices 130a-c. For example, the user device may comprises one or more of a client device, a personal computer, computing station, workstation, portable computer, laptop computer, mobile phone, tablet device, smartphone, smartwatch, activity tracker, smart apparel, smart accessory, security and/or monitoring device, a mobile device, a game system, a content output device, an IoT device, or the like. Each user device 130a-c may be configured to determine, generate and/or send requests associated the multicast of the content. For example, the requests (e.g., join requests and/or leave requests) may be sent from one of the user devices 130a-c to a particular network device 121-123 (e.g., network device 122) via the network 124 or another network. For example, each request may be an IGMP request sent via IPv4 or a MLD request sent via IPv6. Each user device 130a-c may be configured to receive content, such as the multicast of the content. For example, the user device 130a-c may receive the content from one of the network devices 121-123 via the network 124 or another network and may display the content on a display of the user device 130a-c or a display communicably coupled to the user device 130a-c.

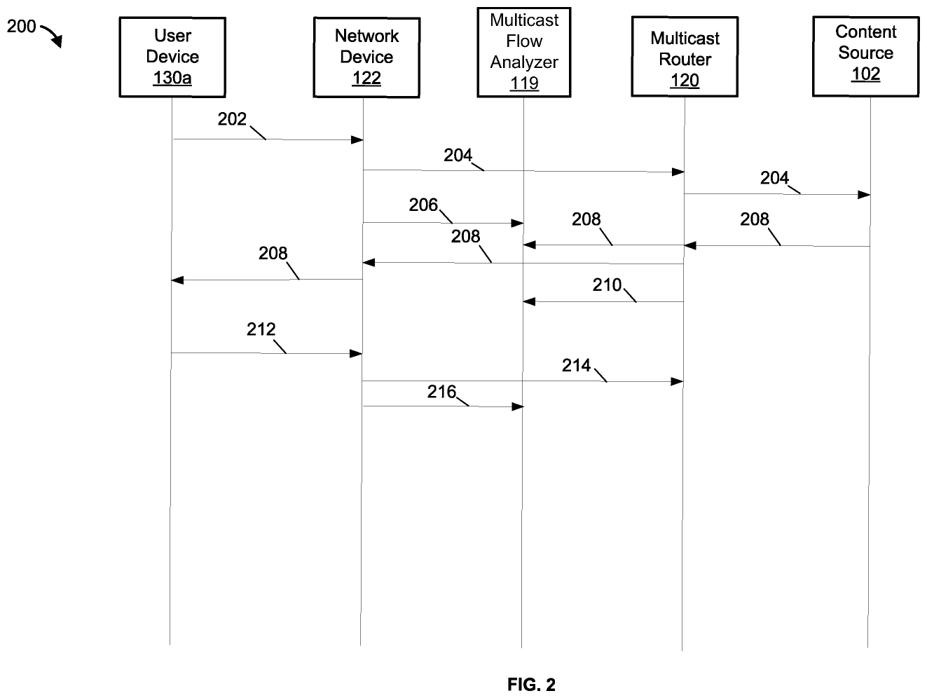

FIG. 2 shows an example diagram 200 for managing a multicast communication session. The communication diagram 200 shows example communications between the user device 130a, network device 122 (e.g. a local multicast router), multicast flow analyzer, a router 120 (e.g., a multicast router), and a content source 102 (e.g., of a plurality of content sources). While the example of FIG. 2 refers to certain computing devices sending and/or receiving certain communications, this is for example purposes only, as the communications discussed herein may be completed by any of the computing devices shown or by other computing devices. Further, while not shown, communication between each of the computing devices above may occur through one or more networks (e.g., the network 124 and/or other networks) to facilitate the sending or transmission of requests, information, and/or content (e.g., video content, audio content, audio/video content, web content, etc.).

A request 202 may be sent or otherwise transmitted. For example, the request 202 may be sent by the user device 130a (e.g., a client device, a personal computer, computing station, workstation, portable computer, laptop computer, mobile phone, tablet device, smartphone, smartwatch, activity tracker, smart apparel, smart accessory, security and/or monitoring device, a mobile device, a game system, a content output device, an IoT device, etc.) and received by the network device 122 (e.g., a router, edge device, or other common network node). For example, the network device 122 may be a local multicast router (e.g., a leaf multicast router). The request 202 may be sent from the user device 130a to the network device 122 via the network 124 or another network.

For example, the request 202 may be a request to join a multicast of content (e.g., a content item, such as video content, audio content, audio/video content, web content, etc.). For example, the request 202 may be an IGMP join request for requests 202 sent via internet protocol version 4 (IPv4) or may be a multicast listener discovery (MLD) join request for requests 202 sent via internet protocol version 6 (IPv6).

The request 202 may comprise at least one of a user device identifier, a multicast source identifier, a multicast group identifier, and/or a start time for the user device 130a to begin receive the content. The user device identifier may be associated with the user device 130a and may uniquely identify the user device 130a. For example, the user device identifier may be at least one of a MAC address and/or a network address. For example, the user device identifier in the request 202 may be merged with other metadata to associate additional user device identifiers with the user device identifier in the request 202. For example, the additional user device identifier associated based on other metadata may be at least one of a user account number, a phone number, or a user name.

The multicast source identifier may be associated with the content source 102 from which the content (e.g., multicast content) is being requested. The multicast source identifier may uniquely identify the content source 102. For example, the multicast source identifier may be at least one of a MAC address or a network address. The multicast group identifier may uniquely identify the content (e.g., a particular content item) being requested. The start time may be a specific time (or time and date) reference (e.g., 12:01 UTC) or may be a timer reference (e.g., a continuous timer reference or clock). For example, the start time may be an indication of a start time associated with the user device 130a receiving the multicast of the content.

The network device 122 may store all or a portion of the join request 202 in memory of the network device 122 or in another storage device. For example, the network device 122 may store at least one of the user device identifier, the multicast source identifier, and/or the multicast group identifier in a table or other database. Upon later receipt of the multicast of the requested content, the network device 122 may subsequently reference the stored information to determine that the user device 130a requested to receive the multicast of the content.

A request 204 may be sent or otherwise transmitted. For example, the request 204 may be sent by the network device 122 and received by another network device (e.g., a multicast router 120). For example, the multicast router 120 may be a remote multicast router communicably positioned further from the user device 130a than the network device 122 and closer to the content source 102. The request 204 may be sent from the network device 122 to the multicast router 120 via the network 124 or another network.

The request 204 may be a join request. For example, the request 204 may be a join request to receive the content (e.g., a multicast of the content). For example, the request 204 may be an IGMP join request sent via IPv4 or may be an MLD join request sent via IPv6. The request 204 may be the same or different than the request 202. For example, the network device 122 may modify the request 202 to create the request 204. For example, upon receiving the request 202, the network device 122 may remove the user device identifier and/or the start time from the request 202 to create the request 204. For example, the request 204 may comprise at least one of the multicast source identifier or the multicast group identifier. For example, the request 204 may not include the user device identifier associated with the user device 130a and/or the start time from the request 202.

The request 204 may further be sent or otherwise transmitted to the content source 102. The content source 102 may be a multicast content source configured to send a multicast of one or more content (e.g., one or more content items). For example, the request 204 may be sent by the multicast router 120 (or another network device) and received by the content source 102. While the example of FIG. 2 shows the request 204 being sent from the network device 122 to the content source 102 through a single multicast router 120, this is for example purposes only. In certain examples, the request 204 may pass through any number of multicast routers (or other network devices) along its communication path from the network device 122 to the content source 102. The request 204 may be sent from the multicast router 120 to the content source 102 via the network 124 or another network.

A message 206 may be sent or otherwise transmitted. For example, the message 206 may be sent or otherwise transmitted from the network device 122 to the multicast flow analyzer 119 or another computing device. The message 206 may be sent from the network device 122 to the multicast flow analyzer 119 via the network 124 or another network. For example, the message 206 may be or comprise the request to join the multicast of the content. For example, the message 206 may be an IGMP join request sent via IPv4 or may be a MLD join request sent via IPv6.

For example, the message 206 may be or otherwise comprise all or a portion of the request 202 or the data in the request 202. For example, the message 206 may comprise at least one of the user device identifier, the multicast source identifier, or the multicast group identifier. The second request may also comprise a start time for the user device 130a to begin receiving the content. For example, the network device 122 may add, insert, append, or otherwise include the start time (generated by the network device 122) with all or a portion of the request 202 to create or generate the message 206. The start time may be a specific time (or time and date) reference (e.g., 12:01 UTC) or may be a timer reference (e.g., a continuous timer reference or clock). For example, the start time may be an indication of a start time associated with the user device 130a receiving the multicast of the content. For example, the network device 122 may comprise a clock or timer from which the network device 122 determines the start time to include in the message 206. For example, the start time may be a time stamp appended, inserted, or otherwise included in the message 206.

For example, the network device 122 may repackage the request 202 to create the message 206. For example, the network device 122 may modify the request 202 to create the message 206. For example, the network device 122 may encapsulate the start time with all or the portion of the request 202 to create the message 206. For example, the encapsulated second request may comprise a header that identifies the source of the message 206 as the network device 122 and the destination as the multicast flow analyzer 119 and comprises the user device identifier, the multicast source identifier, the multicast group identifier, and/or the start time as data within the message 206.

The message 206 may comprise data from the request 202 for one user device (e.g., the user device 130a) to join the multicast of the content or may be a combination of multiple requests from multiple user devices to join the multicast of the content for the particular content source 102. For example, the network device 122 may receive multiple requests from multiple user devices 130a-c to join the multicast of the content. The network device 122 may determine that each of the requests is for the same content source and/or the same content. The network device 122 may combine the multiple requests (or all or a portion of the data therein) into the message 206. This combined second request may comprise the user device identifier for each of the multiple user devices requesting to join or receive the multicast of the content, along with the multicast source identifier, the multicast group identifier, and/or the start time (e.g., time stamp) created by the network device 122.

The multicast flow analyzer 119 or another computing device may receive the message 206. The multicast flow analyzer 119 may parse or determine the data within the message 206. For example, the multicast flow analyzer 119 may determine that the data within the message 206 comprises at least one of one or more user device identifiers, the multicast source identifier, the multicast group identifier, and/or the start time.

The multicast flow analyzer 119 may store all or a portion of the received data from the message 206. For example, the multicast flow analyzer 119 may insert the data into a database, table, or other record-storing system to monitor when user devices begin receiving the multicast of the content. For example, the multicast flow analyzer 119 may generate and store a separate data record for each user device (e.g., the user devices 130a-c) each time the particular user device requests to join a multicast of a particular content. For example, the generated data record or stored data may comprise the user device identifier, the multicast source identifier, the multicast group identifier, the start time (indicating a start time associated with the user device receiving the multicast of the content), an end time (which may be received at a different point in time and indicating an end time associated with the user device leaving or no longer receiving the multicast of the content), and the quantity of data or data packets received by the user device while receiving the multicast of the content (which may be received at a different point in time).

The requested content 208 (e.g., a content item, such as video content, audio content, audio/video content, web content, etc.) may be sent or otherwise transmitted. For example, the requested content 208 may be a live stream of content or recorded content. For example, the requested content 208 may be sent by the content source 102 to the multicast router 120 and/or other network devices (e.g., other multicast routers). The requested content 208 may be sent from the content source 102 to the multicast router 120 via the network 124 or another network. The requested content 208 may comprise metadata that comprises at least one of the multicast source identifier or the multicast group identifier.

The requested content 208 may be further sent or transmitted from the multicast router 120 to other downstream multicast routers, such as the network device 122. The requested content 208 may be further sent or transmitted from the multicast router 120 to the multicast flow analyzer 119. While the example of FIG. 2 shows a direct transmission from the multicast router 120 to the network device 122 and the multicast flow analyzer 119, this is for example purposes only, as the sending or transmission of the requested content 208 from the multicast router 120 may pass through additional multicast routers (not shown), via the network 124 or another network, before being received by the network device 122 and/or the multicast flow analyzer 119.

Information 210 associated with the requested content 208 may be determined. For example, the multicast router 120 or another computing device may determine the information 210 from the requested content 208. For example, at least a portion of the information 210 may be determined from metadata included with or associated with the requested content 208. For example, as least a portion of the information 210 determined from the metadata may comprise the multicast source identifier or the multicast group identifier for the requested content. The multicast router 120 may also determine the number of data packets being sent (or a reference packet number for the first packet of the requested content 208 received by the multicast router 120 during a particular time period) and/or the quantity of data included in the requested content 208 during the particular time period as the requested content 208 is received by the multicast router and passed to other multicast routers and/or the network device. The multicast router 120 may comprise a clock or timer from which the multicast router 120 determines an indicator of the current time (e.g., a time stamp) to associate with the number of data packets, the reference packet number, or the quantity of data passing through the multicast router 120 and can associate the indicator of the current time with the number of packets, the reference packet number, or the quantity of data passing through the multicast router 120 at that time and may include that in the information 210. The information 210 may be sent or otherwise transmitted to the multicast flow analyzer 119 via the network 124 or another network.

For example, the multicast flow analyzer 119 may receive the information 210 associated with the requested content 208 from the multicast router 120. In another example, the multicast flow analyzer 119 may determine the information 210 associated with the requested content 208 from an evaluation of the multicast of the content by the multicast flow analyzer 119. The multicast flow analyzer 119 may store all or a portion of the data included in the information 210. For example, the multicast flow analyzer 119 may insert the data into a database, table, or other record-storing system of the multicast flow analyzer 119 to determine a number of packets and/or the quantity of data being transmitted or sent in a multicast of content at a particular period of time. For example, the multicast flow analyzer 119 may generate and store a separate data record for each multicast of content and may comprise each item of information 210 received by the multicast flow analyzer 119 in the respective data record for the particular multicast of content. For example, the data record or stored data may comprise the multicast source identifier, the multicast group identifier, the indicator of the current time (e.g. the time stamp), the number of packets, the reference packet number, and/or the quantity of data passing through the multicast router 120 at that particular time.

The network device 122 may receive the requested content 208. The network device 122 may evaluate the metadata of the requested content 208 to determine at least one of the multicast source identifier or the multicast group identifier. The network device 122 may determine which user devices (e.g., user device 130a) requested to join or receive the multicast of the content. For example, the network device 122 may compare the multicast source identifier to stored records of requests (e.g., request 202) received by the network device 122. For example, the network device 122 may determine which stored records comprise a matching multicast source identifier for a pending or open request to join or receive the multicast of the content. For example, the network device 122 may, for each stored record including the same or matching multicast source identifier, determine the user device identifier for that particular record. The network device may send or otherwise transmit the requested content 208 to each user device (e.g., user device 130a) associated with the user device identifier in the record having the matching multicast source identifier. For example, the requested content 208 may be sent from the network device 122 to the user device 130a via the network 124 or another network.

The user device 130a may receive the requested content 208. The requested content 208 may comprise audio content and video content. The user device 130a may display all or a portion of the requested content 208 (e.g., the video content) on a display of the user device 130a or a display communicably coupled to the user device 130a. The user device 130a may also display all or another portion of the requested content 208 (e.g., the audio content) through a speaker of the user device 130a or a speaker communicably coupled to the user device 130a.

A request 212 may be sent or otherwise transmitted. For example, the request 212 may be sent by the user device 130a and received by the network device 122. The request 212 may be sent from the user device 130a to the network device 122 via the network 124 or another network. For example, the request 212 may be a request to leave or stop receiving a multicast of content (e.g., a content item, such as video content, audio content, audio/video content, web content, etc.). For example, the request 212 may be an IGMP leave request sent via IPv4 or may be a MLD leave request sent via IPv6.

The request 212 may comprise at least one of the user device identifier, the multicast source identifier, the multicast group identifier, and/or an end time for the user device 130a to stop receiving the content. The end time may be a specific time (or time and date) reference (e.g., 12:01 UTC) or may be a timer reference (e.g., a continuous timer reference or clock). For example, the end time may be an indication of an end time associated with the user device 130a leaving or no longer receiving the multicast of the content.

The network device 122 may store all or a portion of the leave request 212 in memory of the network device 122 or in another storage device. For example, the network device 122 may store at least one of the user device identifier, the multicast source identifier, and/or the multicast group identifier in a table or other database.

A request 214 may be sent or otherwise transmitted. For example, the request 214 may be sent by the network device 122 and received by another network device (e.g., a multicast router 120). The request 214 may be sent from the network device 122 to the multicast router 120 via the network 124 or another network.

The request 214 may be a leave request. For example, the request 214 may be a leave request to stop receiving or leave a viewing of the content (e.g., the multicast of the content). For example, the request 214 may be an IGMP leave request sent via IPv4 or may be an MLD leave request sent via IPv6. The request 214 may be the same or different than the request 212. For example, the network device 122 may modify the request 212 to create the request 214. For example, upon receiving the request 212, the network device 122 may remove the user device identifier and/or the end time from the request 212 to create the request 214. For example, the request 214 may comprise at least one of the multicast source identifier or the multicast group identifier. For example, the request 214 may not include the user device identifier associated with the user device 130a and/or the end time from the request 212. The request 214 may also comprise an identifier of the network device 122.

The multicast router 120 may receive the request 214. The multicast router 120 may determine if there are any open requests to continue receiving the multicast of the content. For example, if four user devices sent join requests 202 to receive the multicast of the content through the network device 122 and all four user devices have subsequently leave requests 212 to leave or no longer receive the content, then there may be no open requests through the network device 122 to receive the content and the multicast router 120 may discontinue sending the content to the network device 122 and/or the network device 122 may stop receiving the multicast of the content.

A second message 216 may be sent or otherwise transmitted. For example, the second message 216 may be sent or otherwise transmitted from the network device 122 to the multicast flow analyzer 119 or another computing device. The second message 216 may be sent from the network device 122 to the multicast flow analyzer 119 via the network 124 or another network. For example, the second message 216 may be or comprise the request 212 to leave the multicast of the content. For example, the second message 216 may be an IGMP leave request sent via IPv4 or may be a MLD leave request sent via IPv6.

For example, the second message 216 may be or otherwise comprise all or a portion of the leave request 212 or the data in the leave request 212. For example, the second message 216 may comprise at least one of the user device identifier, the multicast source identifier, or the multicast group identifier. The second message 216 may also comprise an end time for the user device 130a to leave or stop receiving the content. For example, the network device 122 may add, insert, append, or otherwise include the end time (generated by the network device 122) with all or a portion of the leave request 212 to create or generate the second message 216. The end time may be a specific time (or time and date) reference (e.g., 12:01 UTC) or may be a timer reference (e.g., a continuous timer reference or clock). For example, the end time may be an indication of an end time associated with the user device 130a leaving or no longer receiving the multicast of the content. For example, the end time may be determined based on the clock or timer associated with the network device 122. For example, the end time may be a time stamp appended, inserted, or otherwise included in the second message 216.

For example, the network device 122 may repackage the leave request 212 to create the second message 216. For example, the network device 122 may modify the leave request 212 to create the second message 216. For example, the network device 122 may encapsulate the end time with all or the portion of the leave request 212 to create the second message 216. For example, the encapsulated second message 216 may comprise a header that identifies the source of the second message 216 as the network device 122 and the destination as the multicast flow analyzer 119 and includes the user device identifier, the multicast source identifier, the multicast group identifier, and/or the end time as data within the second message 216.

The second message 216 may comprise data from the leave request 212 for one user device (e.g., the user device 130a) to leave the multicast of the content or may be a combination of multiple requests from multiple user devices to leave the multicast of the content for the particular content source 102. For example, the network device 122 may receive multiple leave requests from multiple user devices 130a-c to leave or discontinue receiving the multicast of the content. The network device 122 may determine that each of the leave requests is for the same content source and/or the same content. The network device 122 may combine the multiple leave requests (or all or a portion of the data therein) into the second message 216. This combined second request may comprise the user device identifier for each of the multiple user devices requesting to leave or stop receiving the multicast of the content, along with the multicast source identifier, the multicast group identifier, and/or the end time (e.g., time stamp) created by the network device 122.

The multicast flow analyzer 119 or another computing device may receive the second message 216. The multicast flow analyzer 119 may parse or determine the data within the second message 216. For example, the multicast flow analyzer 119 may determine that the data within the second message 216 comprises at least one of one or more user device identifiers, the multicast source identifier, the multicast group identifier, and/or the end time.

The multicast flow analyzer 119 may store all or a portion of the received data from the second message 216. For example, the multicast flow analyzer 119 may determine a data record that is associated with the (or each) user device identifier in the second message 216. For example, the multicast flow analyzer 119 may compare the user device identifier in the second leave request to the user device identifier in each data record to determine if the user device identifier in the second leave request matches any of the user device identifiers in each data record. Data from the second message 216 may be added to the data record associated with the user device identifier in the second message 216. For example, the multicast flow analyzer 119 may store the end time from the second message 216 in the associated data record. For example, the user device identifier, the multicast source identifier, and/or the multicast group identifier from the second message 216 may not be stored in the associated data record because that information may already be stored in the associated data record based on information from the message 206.

Upon receiving the end time for a particular user device (e.g., the user device 130a) to receive the multicast of the content, the multicast flow analyzer 119 may determine the number of packets or quantity of data that the user device 130a, associated with the user device identifier in the data record, received based on the user device 130a receiving the multicast of the content. For example, the multicast flow analyzer 119 may determine the packet number for the packet of the content at the start time in the data record and the packet number for the packet of the content at the end time in the data record. The particular packet number and time reference for the particular content or multicast content source may have been received by the multicast flow analyzer 119 in one or more of the plurality of information 210 transmissions from the multicast router 120 to the multicast flow analyzer 119. The multicast flow analyzer 119 may then subtract the packet number at the start time from the packet number at the end time to determine the number of packets received by the user device 130a while receiving the multicast of the content. For example, for a user device 130a beginning to receive the content at T1, when the packet number being sent by the multicast router 120 was 1000, and ending receipt of the content at T5, when the packet number being sent by the multicast router 120 was 42000, the number of packets of the multicast of content received by the user device 130a may be determined as 42000 packets−1000 packets=41000 packets. The multicast flow analyzer 119 may associate or store the number of packets received by the user device 130a in the data record associated with the user device 130a (e.g., based on the user device identifier).

For example, the multicast flow analyzer 119 may determine the quantity of data received by the user device 130a based on the number of packets received by the user device 130a. For example, the quantity of data per packet may be a known or estimated value and the product of the number of packets and the quantity of data per packet may be calculated by the multicast flow analyzer 119. The multicast flow analyzer 119 may associate or store the quantity of data received by the user device 130a in the data record associated with the user device 130a (e.g., based on the user device identifier).

For example, the multicast flow analyzer 119 may determine the quantity of data received by the user device 130a from the multicast of the content. For example, based on the start time and the end time for the user device 130a receiving the multicast of the content, the multicast flow analyzer may evaluate the data information transmitted for the multicast of the content during the time period between the start time and end time for the user device. The quantity of data being transmitted as part of the transmission of the multicast of content and time reference for the particular content or multicast content source may have been received by the multicast flow analyzer 119 in one or more of the plurality of information 210 transmissions from the multicast router 120 to the multicast flow analyzer 119. For example, the multicast flow analyzer 119 may determine the sum of the data in the information 210 for the period between the start time and the end time for the user device 130a receiving the multicast of the content to determine to total quantity of data received by the user device 130a. The multicast flow analyzer 119 may associate or store the quantity of data received by the user device 130a in the data record associated with the user device 130a (e.g., based on the user device identifier).

Quality issues related to the requested content 208 may also be evaluated for the multicast of the content and for the user device 130a receiving the multicast of the content. For example, issues related to jitter, latency, packet drop, packet re-transmit rate, video bitrate variance, and/or out-of-order RTP packet count may be evaluated for the multicast of the content based on an evaluation of the content and for determining if the user device 130a received content with quality issues based on the data record of the user device 130a receiving the requested content 208. For example, a computing device (e.g., the multicast flow analyzer 119 or another computing device) may evaluate the requested content 208 for quality issues, identify one or more quality issues in the requested content 208 and determine the timing of the one or more quality issues. For example, the computing device may determine the start time and/or the end time for the user device 130a receiving the requested content 208 from the data record associated with the user device 130a. The computing device may also determine other user devices receiving the requested content 208 during all or a portion of the same time period (between the start time and the end time) as that of the user device 130a from data records associated with the user device. Based on the information from the data records (e.g., the start time and the end time) and the time quality issues were identified in the requested content 208, the computing device may determine if the user device was receiving the requested content 208 during the time period or reference of the quality issues identified in the requested content. For example, the computing device may cause the receipt of the multicast of the content by the user devices 130a-c to change from the current content source 102 to a different content source. For example, the computing device may, based on one or more quality issues, send a message or signal to the content source 102 or the packager 106 of the requested content 208 to adjust the bandwidth of the content 208 being multicast. For example, the multicast flow analyzer 119 may send a message to the content source 102 or the packager 106 to reduce or lower the bandwidth of the requested content 208 being multicast. For example, the computing device may, based on one or more quality issues, send a message or signal to a network monitoring system to conduct further analysis regarding the multicast and the content 208 being multicast.

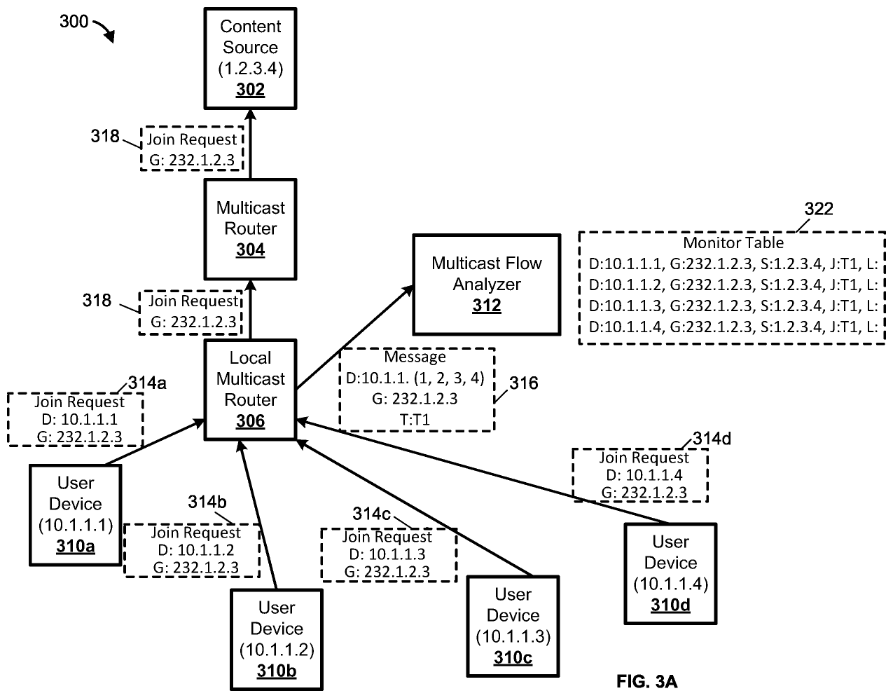

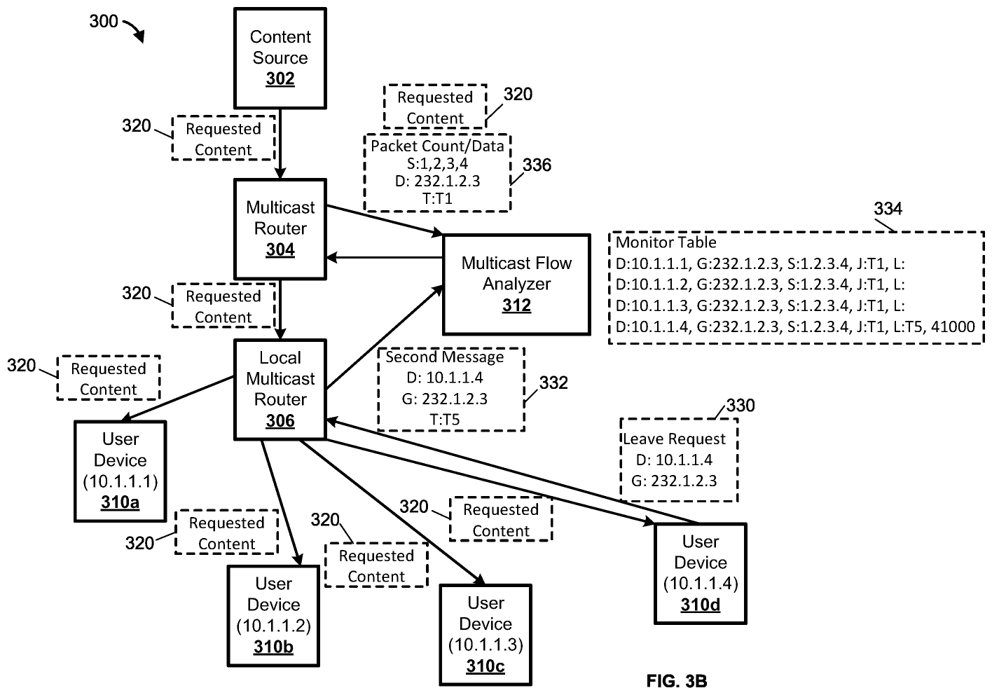

FIGS. 3A-B shows an example system 300 for managing a multicast communication session. The system 300 shows example computing devices and/or portions of computing devices that may interact with one another during a multicast communication session. While a number of computing devices are shown, this is for example purposes only. Additional or fewer computing devices may be included within the system. Further, the system 300 shows example communications between computing devices or portions of computing device. While the example communications show direct communications between one computing device and another, this is for example purposes only, as networks (e.g., network 124) or other computing devices not shown may be intermediary devices along a communication path between one or more of the computing devices shown. Furthermore, while the example of FIGS. 3A-B refers to certain computing devices sending and/or receiving certain communications, this is for example purposes only, as the communications discussed herein may be completed by any of the computing devices shown or by other computing devices.

A request 314a-d may be sent or otherwise transmitted. For example, the request 314a-d may be sent by one or more of the user device 310a-d (e.g., a client device, a personal computer, computing station, workstation, portable computer, laptop computer, mobile phone, tablet device, smartphone, smartwatch, activity tracker, smart apparel, smart accessory, security and/or monitoring device, a mobile device, a game system, a content output device, an IoT device, etc.) and received by a network device (e.g., a router, such as a multicast router or other computing device). For example, the network device may be a local multicast router 306 (e.g., a leaf multicast router). Each request 314a-d may be sent from the respective user device 310a-d to the local multicast router 306 via the network 124 or another network.

For example, each request 314a-d may be a request to join a multicast of content (e.g., a content item, such as video content, audio content, audio/video content, web content, etc.). For example, each request 314a-d may be an IGMP join request sent via IPv4, an MLD join request sent via IPv6 or another form of request.

Each request 314a-d may comprise at least one of a user device identifier, a multicast source identifier, a multicast group identifier, and/or a start time for the respective user device 310a-d to begin receive the content. The user device identifier may be a unique identifier associated with a respective one of the user devices 310a-d and may uniquely identify the respective user device 310a-d (e.g., 10.1.1.1; 10.1.1.2; 10.1.1.3; 10.1.1.4). For example, the user device identifier may be at least one of a MAC address and/or a network address. For example, the user device identifier in the request 314a-d may be merged with other metadata to associate additional user device identifiers with the user device identifier in the request 314a-d. For example, the additional user device identifiers associated based on other metadata may be at least one of a user account number, a phone number, or a user name.

The multicast source identifier may be associated with the content source 302 from which the content (e.g., multicast content) is being requested. The multicast source identifier may uniquely identify the content source 302 (e.g., 1.2.3.4). For example, the multicast source identifier may be at least one of a MAC address or a network address. The multicast group identifier may uniquely identify the content (e.g., a particular content item) or group of the multicast being requested (e.g., 232.1.2.3) and provided by the content source 302. For example, the multicast group identifier may be at least one of a MAC address or a network address. The start time may be a specific time (or time and date) reference (e.g., 12:01 UTC) or may be a timer reference (e.g., a continuous timer reference or clock). For example, the start time may be an indication of a start time associated with the respective user device 310a-d receiving or requesting the multicast of the content.

The local multicast router 306 may store all or a portion of the join requests 314a-d in memory of the local multicast router 306 or in another storage device. For example, the local multicast router 306 may store, from the join requests 314a-d, at least one of the user device identifier, the multicast source identifier, and/or the multicast group identifier in a table or other database. Upon later receipt of the multicast of the requested content, the local multicast router 306 may subsequently reference the stored information to determine the one or more user devices 310a-d that requested to receive the multicast of the content and may send or otherwise transmit that multicast of the content to those particular user devices 310a-d.

A request 318 may be sent or otherwise transmitted. For example, the request 318 may be sent by the local multicast router 306 and received by another network device (e.g., a multicast router 304). For example, the multicast router 304 may be a remote multicast router communicably positioned further from one or more of the user devices 310a-d than the local multicast router 306 and closer to the content source 302. The request 318 may be sent from the local multicast router 306 to the multicast router 304 via the network 124 or another network.

The request 318 may be a join request. For example, the request 318 may be a join request to receive the content (e.g., a multicast of the content). For example, the request 318 may be an IGMP join request sent via IPv4, an MLD join request sent via IPv6 or another form of request. The request 318 may be the same or different than one or more of or a combination of the requests 314a-d. For example, the local multicast router 306 may modify one or more of the requests 314a-d to create the request 318. For example, upon receiving one or more of the requests 314a-d, the local multicast router 306 may remove the user device identifier and/or the start time from one or more or each of the requests 314a-d to create the request 318. For example, the request 318 may comprise at least one of the multicast source identifier or the multicast group identifier. For example, the request 318 may not include any of the user device identifiers associated with any user device requesting to join the multicast of the content (e.g., the user devices 310a-d) and/or the start time from the one or more of the requests 314a-d.

The request 318 may further be sent or otherwise transmitted to the content source 302. The content source 302 may be a multicast content source configured to send a multicast of one or more content (e.g., one or more content items). For example, the request 318 may be sent by the multicast router 304 (or another network device) and received by the content source 302. While the example of FIG. 3A shows the request 318 being sent from the local multicast router 306 to the content source 302 through a single multicast router 304, this is for example purposes only. In certain examples, the request 318 may pass through any number of multicast routers (or other network devices) along its communication path from the local multicast router 306 to the content source 302. The request 318 may be sent from the multicast router 304 to the content source 302 via the network 124 or another network.

A message 316 may be sent or otherwise transmitted. For example, the message 316 may be sent or otherwise transmitted from the local multicast router 306 to a multicast flow analyzer 312 (e.g., a content deliver analyzer or another computing device). The message 316 may be sent from the local multicast router 306 to the multicast flow analyzer 312 via the network 124 or another network. For example, the message 316 may be or comprise one or more of the requests 314a-d to join the multicast of the content. For example, the message 316 may be or comprise an IGMP join request sent via IPv4, a MLD join request sent via IPv6, or another form of message.

For example, the message 316 may be or otherwise comprise all or a portion of one or more or each of the requests 314a-d or the data in the requests 314a-d. For example, the message 316 may comprise at least one of the user device identifier, the multicast source identifier, or the multicast group identifier from the request 314a-d or group of requests. The message 316 may also comprise a start time for the one or more user devices 310a-d to begin receiving the content. For example, the local multicast router 306 may add, insert, append, or otherwise include the start time (generated by the local multicast router 306) with all or a portion of the request 314a-d to create or generate the message 316. The start time may be a specific time (or time and date) reference (e.g., 12:01 UTC) or may be a timer reference (e.g., a continuous timer reference or clock). For example, the start time may be an indication of a start time associated with each particular user device 310a-d receiving the multicast of the content. For example, the local multicast router 306 may comprise a clock or timer from which the local multicast router 306 determines the start time to include in the message 316. For example, the start time may be a time stamp appended, inserted, or otherwise included in the message 316.

For example, the local multicast router 306 may repackage the one or more requests 314a-d to create the message 316. For example, the local multicast router 306 may modify the one or more requests 314a-d to create the message 316. For example, the local multicast router 306 may encapsulate the start time with all or the portion of the one or more requests 314a-d to create the message 316. For example, the encapsulated message 316 may comprise a header that identifies the source of the message 316 as the local multicast router 306 and the destination as the multicast flow analyzer 312 and comprises the one or more user device identifiers, the multicast source identifier, the multicast group identifier, and/or the start time as data within the message 316.

The message 316 may comprise data from one request (e.g., request 314d) for one user device (e.g., the user device 314d) to join the multicast of the content or may be a combination of multiple requests (e.g., requests 314a-d) from multiple user devices (e.g., user devices 310a-d) to join the multicast of the content for the particular content source 302. For example, the local multicast router 306 may receive multiple requests 314a-d from multiple user devices 310a-d to join the multicast of the content. The local multicast router 306 may determine that each of the requests 314a-d is for the same content source and/or the same content. The local multicast router 306 may combine the multiple requests 314a-d (or all or a portion of the data therein) into the message 316. This combined message 316 may comprise the user device identifier for each of the multiple user devices requesting to join or receive the multicast of the content (e.g., 10.1.1.(1,2,3,4)), along with the multicast source identifier, the multicast group identifier, and/or the start time (e.g., time stamp) created by the local multicast router 306.

The multicast flow analyzer 312 may receive the message 316. The multicast flow analyzer 312 may parse or determine the data within the message 316. For example, the multicast flow analyzer 312 may determine that the data within the message 316 comprises at least one of one or more user device identifiers, the multicast source identifier, the multicast group identifier, and/or the start time.

The multicast flow analyzer 312 may store all or a portion of the received data from the message 316. For example, the multicast flow analyzer 312 may insert the data into a database, table, or other record-storing system (e.g., a monitor table 322) to monitor when user devices begin receiving the multicast of the content. For example, the multicast flow analyzer 312 may generate and store a separate data record for each user device (e.g., the user devices 310a-d) each time the particular user device 310a-d requests to join a multicast of a particular content. For example, the generated data record or stored data may comprise the user device identifier, the multicast source identifier, the multicast group identifier, the start time (indicating a start time associated with the user device receiving the multicast of the content), an end time (which may be received at a different point in time and indicating an end time associated with the user device leaving or no longer receiving the multicast of the content), and the quantity of data or data packets received by the user device while receiving the multicast of the content (which may be received at a different point in time).

Referring to FIG. 3B, the requested content 320 (e.g., a content item, such as video content, audio content, audio/video content, web content, etc.) may be sent or otherwise transmitted. For example, the requested content 320 may be a live stream of content or recorded content. For example, the requested content 320 may be sent by the content source 302 to the multicast router 304 and/or other network devices (e.g., other multicast routers). The requested content 320 may be sent from the content source 302 to the multicast router 304 via the network 124 or another network. The requested content 320 may comprise metadata that comprises at least one of the multicast source identifier or the multicast group identifier.

The requested content 320 may be further sent or transmitted from the multicast router 304 to the multicast flow analyzer 312 and other downstream multicast routers, such as the local multicast router 306. While the example of FIG. 3B shows a direct transmission from the multicast router 304 to the multicast flow analyzer 312 and the local multicast router 306, this is for example purposes only, as the sending or transmission of the requested content 320 from the multicast router 120 may pass through additional multicast routers (not shown), via the network 124 or another network, before being received by the multicast flow analyzer 312 and/or the local multicast router 306.

Information 336 associated with the requested content 320 may be determined. For example, the multicast router 304 or another computing device may determine the information 336 from the requested content 320. For example, at least a portion of the information 336 may be determined from metadata included with or associated with the requested content 320. For example, as least a portion of the information 336 determined from the metadata may comprise the multicast source identifier or the multicast group identifier for the requested content 320. The multicast router 304 may also determine the number of data packets being sent (or a reference packet number for the first packet of the requested content 320 received by the multicast router 304) during a particular time (e.g. T1) or time period and/or the quantity of data included in the requested content 320 during a particular time (e.g., T1) or a particular time period as the requested content 320 is received by the multicast router 304 and passed to other multicast routers and/or the local multicast router 306. The multicast router 304 may comprise a clock or timer from which the multicast router 304 determines an indicator of the current time (e.g., a time stamp) to associate with the number of data packets, the reference packet number, or the quantity of data passing through the multicast router 304 and can associate the indicator of the current time (e.g., T1) with the number of packets, the reference packet number, or the quantity of data passing through the multicast router 304 at that time and may include that in the information 336. The information 336 may be sent or otherwise transmitted to the multicast flow analyzer 312 via the network 124 or another network.

For example, the multicast flow analyzer 312 may receive the information 336 associated with the requested content 320 from the multicast router 304. For example, the multicast flow analyzer 312 may determine the information 336 associated with the requested content 320 on its own based on an evaluated of the requested content 320 received by the multicast flow analyzer 312. The multicast flow analyzer 312 may store all or a portion of the data included in the information 336. For example, the multicast flow analyzer 312 may insert the data into a database, table, or other record-storing system (e.g., the monitor table 334) of the multicast flow analyzer 312 to determine a number of packets and/or the quantity of data being transmitted or sent in a multicast of content at or during a particular period of time. For example, the multicast flow analyzer 312 may generate and store a separate data record for each multicast of content and may comprise each item of information 336 received by the multicast flow analyzer 312 in the respective data record for the particular multicast of content. For example, the generated data record or stored data may comprise the multicast source identifier, the multicast group identifier, the indicator of the current time (e.g. the time stamp, T1), the number of packets, the reference packet number, and/or the quantity of data passing through the multicast router 304 at that particular time.

The local multicast router 306 may receive the requested content 320. The local multicast router 306 may evaluate the metadata of the requested content 320 to determine at least one of the multicast source identifier or the multicast group identifier. The local multicast router 306 may determine which user devices (e.g., user devices 310a-d) requested to join or receive the multicast of the content. For example, the local multicast router 306 may compare the multicast source identifier to stored records of requests (e.g., requests 314a-d) received by the local multicast router 306. For example, the local multicast router 306 may determine which stored records include a matching multicast source identifier for a pending or open request to join or receive the multicast of the content. For example, the local multicast router 306 may, for each stored record including the same or matching multicast source identifier, determine the user device identifier for that particular record. The local multicast router 306 may send or otherwise transmit the requested content 320 to each user device (e.g., user devices 310a-d) associated with the user device identifier in the record having the matching multicast source identifier. For example, the requested content 320 may be sent from the local multicast router 306 to the user devices 310a-d via the network 124 or another network.

The user devices 310a-d may receive the requested content 320. The requested content 320 may comprise audio content and video content. One or more of the user devices 310a-d may display all or a portion of the requested content 320 (e.g., the video content) on a display of the user device 310a-d or a display communicably coupled to the user device 310a-d. One or more of the user device 310a-d may also output all or another portion of the requested content 208 (e.g., the audio content) through a speaker of the user device 310a-d or a speaker communicably coupled to the particular user device 310a-d.

A request 330 may be sent or otherwise transmitted. For example, the request 330 may be sent by the user device 310d and received by the local multicast router 306. The request 330 may be sent from the user device 310d to the local multicast router 306 via the network 124 or another network. For example, the request 330 may be a request to leave or stop receiving a multicast of content. For example, the leave request 330 may be an IGMP leave request sent via IPv4, a MLD leave request sent via IPv6, or another form of leave request.

The leave request 330 may comprise at least one of the user device identifier, the multicast source identifier, the multicast group identifier, and/or an end time for the user device 310d to stop receiving the content. The end time may be a specific time (or time and date) reference (e.g., 12:01 UTC) or may be a timer reference (e.g., a continuous timer reference or clock). For example, the end time may be an indication of an end time associated with the user device 310d leaving or no longer receiving the multicast of the content.

The local multicast router 306 may store all or a portion of the leave request 330 in memory of the local multicast router 306 or in another storage device. For example, the local multicast router 306 may store at least one of the user device identifier, the multicast source identifier, and/or the multicast group identifier in a table or other database. Based on the leave request 330, the local multicast router 306 may discontinue sending the requested content 320 to the user device 310d.

A second message 332 may be sent or otherwise transmitted. For example, the second message 332 may be sent or otherwise transmitted from the local multicast router 306 to the multicast flow analyzer 312. The second message 332 may be sent from the local multicast router 306 to the multicast flow analyzer 312 via the network 124 or another network. For example, the second message 332 may be or comprise the leave request 330 by the user device 310d to leave the multicast of the content. For example, the second message 332 may be or comprise an IGMP leave request sent via IPv4, a MLD leave request sent via IPv6, or another form of leave message.

For example, the second message 332 may be or otherwise comprise all or a portion of the leave request 330 or the data in the leave request 330. For example, the second message 332 may comprise at least one of the user device identifier, the multicast source identifier, or the multicast group identifier. The second message 332 may also comprise an end time for the user device 310d to leave or stop receiving the content 320. For example, the local multicast router 306 may add, insert, append, or otherwise include the end time (generated by the local multicast router 306) with all or a portion of the leave request 330 to create or generate the second message 332. The end time may be a specific time (or time and date) reference (e.g., 12:01 UTC) or may be a timer reference (e.g., a continuous timer reference or clock). For example, the end time may be an indication of an end time associated with the user device 310d leaving or no longer receiving the multicast of the content 320. For example, the end time may be determined based on the clock or timer associated with the local multicast router 306. For example, the end time may be a time stamp appended, inserted, or otherwise included by the local multicast router 306 into the second message 332.

For example, the local multicast router 306 may repackage the leave request 330 to create the second message 332. For example, the local multicast router 306 may modify the leave request 330 to create the second message 332. For example, the local multicast router 306 may encapsulate the end time (generated by the local multicast router 330) with all or the portion of the leave request 330 to create the second message 332. For example, the encapsulated second message 332 may comprise a header that identifies the source of the second message 332 as the local multicast router 306 and the destination as the multicast flow analyzer 312 and comprises one or more of the user device identifier, the multicast source identifier, the multicast group identifier, and/or the end time as data within the second message 332.

The multicast flow analyzer 312 may receive the second message 332. The multicast flow analyzer 312 may parse or determine the data within the second message 332. For example, the multicast flow analyzer 312 may determine that the data within the second message 332 comprises at least one of one or more user device identifiers, the multicast source identifier, the multicast group identifier, and/or the end time.

The multicast flow analyzer 312 may store all or a portion of the received data from the second message 332. For example, the multicast flow analyzer 312 may determine a data record that is associated with the (or each) user device identifier in the second message 332. For example, the multicast flow analyzer 312 may compare the user device identifier in the second message 332 to the user device identifier in each data record to determine if the user device identifier in the second message 332 matches any of the user device identifiers in each data record. Data from the second message 332 may be added to the data record associated with the user device identifier in the second message 332. For example, the multicast flow analyzer 312 may store the end time from the second message 332 in the associated data record. For example, the user device identifier, the multicast source identifier, and/or the multicast group identifier from the second message 332 may not be stored in the associated data record because that information may already be stored in the associated data record based on information from the message 316.

Upon receiving the end time for a particular user device (e.g., the user device 310d) to receive the multicast of the content 320, the multicast flow analyzer 312 may determine the number of packets or quantity of data that the user device 310d, associated with the user device identifier in the data record, received based on the user device 310d receiving the multicast of the content 320. For example, the multicast flow analyzer 312 may determine the packet number for the packet of the content at the start time in the data record and the packet number for the packet of the content at the end time in the data record. The particular packet number and time reference for the particular content or multicast content source may have been received by the multicast flow analyzer 312 in one or more of the plurality of information 336 transmissions from the multicast router 304 to the multicast flow analyzer 312. The multicast flow analyzer 312 may then subtract the packet number at the start time from the packet number at the end time to determine the number of packets received by the user device 310d while receiving the multicast of the content 320. For example, for a user device 310d beginning to receive the content at T1, when the packet number being sent by the multicast router 304 was 1000, and ending receipt of the content at T5, when the packet number being sent by the multicast router 304 was 42000, the number of packets of the multicast of content received by the user device 310d may be determined as 42000 packets−1000 packets=41000 packets. The multicast flow analyzer 312 may associate or store the number of packets received by the user device 310d in the data record associated with the user device 310d (e.g., based on the user device identifier).

For example, the multicast flow analyzer 312 may determine the quantity of data received by the user device 310d based on the number of packets received by the user device 310d. For example, the quantity of data per packet may be a known or estimated value and the product of the number of packets and the quantity of data per packet may be calculated by the multicast flow analyzer 312. The multicast flow analyzer 312 may associate or store the quantity of data received by the user device 310d in the data record associated with the user device 310d (e.g., based on the user device identifier).

For example, the multicast flow analyzer 312 may determine the quantity of data received by the user device 310d from the multicast of the content 320. For example, based on the start time and the end time for the user device 310d receiving the multicast of the content, the multicast flow analyzer 312 may evaluate the data information transmitted for the multicast of the content during the time period between the start time and end time for the user device. The quantity of data being transmitted as part of the transmission of the multicast of content and time reference for the particular content or multicast content source may have been received by the multicast flow analyzer 312 in one or more of the plurality of information 336 transmissions from the multicast router 304 to the multicast flow analyzer 312. For example, the multicast flow analyzer 312 may determine the sum of the data in the information 336 for the period between the start time and the end time for the user device 310d receiving the multicast of the content 320 to determine a total quantity of data received by the user device 310d. The multicast flow analyzer 312 may associate or store the quantity of data received by the user device 310d in the data record associated with the user device 310d (e.g., based on the user device identifier).

Quality issues related to the requested content 320 may also be evaluated for the multicast of the content and for the user device 310d receiving the multicast of the content. For example, quality issues related to jitter, latency, packet drop, packet re-transmit rate, video bitrate variance, and/or out-of-order RTP packet count may be evaluated for the multicast of the content based on an evaluation of the content and for determining if the user device 310d received content with quality issues based on the data record of the user device 310d receiving the requested content 320. For example, the multicast flow analyzer 312 may evaluate the requested content 320 for quality issues, identify one or more quality issues in the requested content 320 and determine the timing of the one or more quality issues. For example, the multicast flow analyzer 312 may determine the start time and/or the end time for the user device 310d receiving the requested content 320 from the data record associated with the user device 310d in, for example, the monitor table 334. The multicast flow analyzer 312 may also determine other user devices receiving the requested content 320 during all or a portion of the same time period (between the start time and the end time) as that of the user device 310d from data records associated with the user device. Based on the information from the data record(s) (e.g., the start time and the end time) and the time quality issues were identified in the requested content 320, the multicast flow analyzer 312 may determine if the user device 310d was receiving the requested content 320 during the time period of the quality issues identified in the requested content. For example, the multicast flow analyzer 312 may cause the receipt of the multicast of the content by the user device 310d to change from the current content source 302 to a different content source. For example, the multicast flow analyzer 312 may, based on one or more quality issues, send a message or signal to the content source 302 of the requested content 320 to adjust the bandwidth of the requested content 320 being transmitted via multicast. For example, the multicast flow analyzer 312 may send a message to the content source 302 to reduce or lower the bandwidth of the requested content 320 being multicast. For example, the multicast flow analyzer 312 may, based on one or more quality issues, send a message or signal to a network monitoring system to conduct further analysis regarding the multicast and the requested content 320 being multicast.

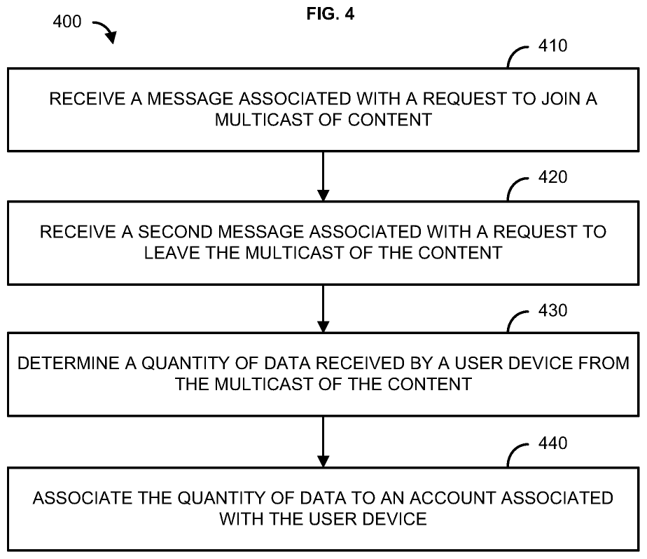

FIG. 4 is a flowchart showing an example method 400 for managing a multicast communication session. The methods described in FIG. 4 may be completed by a computing device (e.g., the multicast flow analyzer 119, multicast flow analyzer 312 or any other computing device). While the example of FIG. 4 describes methods being completed by the computing device, this is for example purposes only, as all or any portion of the method 400 may be completed by any of the computing devices described herein.

At 410, a message associated with a request to join a multicast of content may be received. For example, the message may be received by the computing device (e.g., the multicast flow analyzer 119 or the multicast flow analyzer 312). For example, the message may be received from a second computing device (e.g., a network device 122, such as a local multicast router 306). For example, the message may be received by the computing device from the second computing device via the network 124 or another network. The content may comprise video content, audio content, audio/video content, web content or the like. The message may be an IGMP join request sent via IPv4, a MLD join request sent via IPv6, or another form of message. For example, the message may be the same or substantially similar to the message 206, 316.

For example, the message may be a modified version of a request to join the multicast of the content (e.g., the join request 202, 314a-d) received by the second computing device from another computing device (e.g., a user device 130a-c, 310a-d). The message may comprise data from one request to join the multicast of the content (e.g., the join request 202, 314a-d) for one user device to join the multicast of the content or may be a combination of multiple requests to join the multicast of the content (e.g., the join request 202, 314a-d) from multiple user devices to join the multicast of the content for the particular content source.

The message may comprise a header indicating the second computing device as the source of the message and the computing device as the destination of the message. The message may also comprise data (e.g., within a body of the request) comprising a user device identifier, a multicast source identifier, a multicast group identifier, and/or a start time for a user device (e.g., the user device 130a, 310d) associated with the user device identifier to begin receiving the multicast of the content.

The user device identifier may be associated with the user device (e.g., 130a, 310d) and may uniquely identify the user device. For example, the user device identifier may be at least one of a MAC address and/or a network address. For example, the user device identifier in the message may be merged with other metadata to associate additional user device identifiers with the user device identifier in the message. For example, the additional user device identifiers associated based on other metadata may be at least one of a user account number, a phone number, or a user name.

The multicast source identifier may be associated with a content source (e.g., the content source 102, 302) from which the content is being requested. The multicast source identifier may uniquely identify the content source. For example, the multicast source identifier may be at least one of a MAC address or a network address. The multicast group identifier may uniquely identify the content (e.g., a particular content item) being requested. For example, the multicast group identifier may be at least one of a MAC address or a network address. The start time may be a specific time (or time and date) reference (e.g., 12:01 UTC) or may be a timer reference (e.g., a continuous timer reference or clock). For example, the start time may be an indication of a start time associated with the user device receiving the multicast of the content. For example, the start time may be a time stamp appended, inserted, or otherwise included by the second computing device into the message along with other data from the request to join the multicast of the content received from one or more of the user devices 130a-c.

The computing device (e.g., the multicast flow analyzer 119 or the multicast flow analyzer 312) may parse or determine the data within the message. For example, the computing device may determine that the data within the message comprises at least one of one or more user device identifiers, the multicast source identifier, the multicast group identifier, and/or the start time. The computing device may store all or a portion of the data from the message associated with the request to join the multicast of the content. For example, the computing device may insert the data into a database, table, or other record-storing system (e.g., a monitor table 322) to monitor when user devices begin receiving the multicast of the content. For example, the computing device may generate and store a separate data record for each user device each time the particular user device requests to join a multicast of a particular content. For example, the generated data record or stored data may comprise the user device identifier, the multicast source identifier, the multicast group identifier, the start time (indicating a start time associated with the user device receiving the multicast of the content), an end time (which may be received at a different point in time and indicating an end time associated with the user device leaving or no longer receiving the multicast of the content), and the quantity of data or data packets received by the user device while receiving the multicast of the content (which may be received at a different point in time).

At 420, a second message associated with a request to leave the multicast of the content may be received. For example, the second message may be received by the computing device (e.g., the multicast flow analyzer 119 or the multicast flow analyzer 312). For example, the second message may be received from the second computing device (e.g., the network device 122, such as the local multicast router 306). For example, the second message may be received by the computing device from the second computing device via the network 124 or another network. For example, the second message may be an IGMP leave request sent via IPv4, a MLD leave request sent via IPv6, or another form of message. For example, the second message associated with the request to leave the multicast of the content may be the same or substantially similar to the second message 216, 332.

For example, the second message may be a modified version of a request to leave the multicast of the content (e.g., the leave request 212, 330) received by the second computing device from another computing device (e.g., the user devices 130a-c, 310a-d). The second message may comprise data from one request to leave the multicast of the content (e.g., the leave request 212, 330) for one user device 130a-c or may be a combination of data from multiple requests to leave the multicast of the content (e.g., the leave request 212, 330) from multiple user devices 130a-c to leave the multicast of the content for the particular content source.

The second message may comprise a header indicating the second computing device as the source of the second message and the computing device as the destination of the second message. The second message may also comprise data (e.g., within a body of the second message) comprising a user device identifier, a multicast source identifier, a multicast group identifier, and/or an end time for a user device (e.g., the user device 130a, 310d) associated with the user device identifier to leave or no longer receive the multicast of the content. The end time may be a specific time (or time and date) reference (e.g., 12:01 UTC) or may be a timer reference (e.g., a continuous timer reference or clock). For example, the end time may be an indication of an end time associated with the user device leaving or no longer receiving the multicast of the content 320. For example, the end time may be a time stamp appended, inserted, or otherwise included by the second computing device into the second message along with other data from the request to leave the multicast of the content.

The computing device may parse or determine the data within the second message. For example, the computing device may determine that the data within the second message comprises at least one of one or more user device identifiers, the multicast source identifier, the multicast group identifier, and/or the end time.

The computing device may store all or a portion of the received data from the second message. For example, the computing device may determine a data record (e.g., in the monitor table 334) that is associated with the (or each) user device identifier in the second message. For example, the computing device may compare the user device identifier in the second message to the user device identifier in each data record to determine if the user device identifier in the second message matches any of the user device identifiers in each data record. Data from the second message may be added to the data record associated with the user device identifier in the second message. For example, the computing device may store the end time from the second message in the associated data record. For example, the user device identifier, the multicast source identifier, and/or the multicast group identifier from the second message may not be stored in the associated data record because that information may already be stored in the associated data record based on information from the message associated with the request to join the multicast of the content.

At 430, a quantity of data received by the user device (e.g., the user device 130a, 310d) from the multicast of the content may be determined. For example, the quantity of data received by the user device may be determined by the computing device (e.g., the multicast flow analyzer 119, multicast flow analyzer 312, or any other computing device). Upon receiving the end time for a particular user device (e.g., the user device 130a, 310d) to receive the multicast of the content, the computing device may determine the quantity of data packets or quantity of data (e.g., quantity of bytes) that the user device associated with the user device identifier in the data record, received while receiving the multicast of the content.

For example, the computing device may determine the packet number for the packet of the content at the start time in the data record and the packet number for the packet of the content at the end time in the data record. For example, the computing device may comprise a record or series of records of the multicast of the content, time entries, the bit rate for each multicast of the content, and the associated packet number of the content being sent or transmitted to the user device. For example, the particular packet number and time reference for the particular content or multicast content source may have been received by the computing device from another computing device (e.g., the multicast router 120, 304). The computing device may then subtract the packet number at the start time from the packet number at the end time to determine the number of packets received by the user device while receiving the multicast of the content. For example, for a user device having a start time of T1, indicating when the user device began receiving the content, when the packet number being sent was 1000, and an end time of T5, indicating when the user device left or was no longer receiving the multicast of the content, when the packet number being sent by the multicast router was 42000, the number of packets of the multicast of the content received by the user device may be determined as 42000 packets−1000 packets=41000 packets. The computing device may associate or store the number of packets received by the user device in the data record associated with the user device (e.g., based on the user device identifier).

For example, the computing device may determine the quantity of data received by the user device based on the number of packets received by the user device while receiving the multicast of the content. For example, the quantity of data per packet may be a known (e.g., via the received bitrate for the content) or estimated value. The computing device may determine the quantity of data received by the user device by calculating the product of the number of packets received by the user device (e.g., 41000) and the quantity of data per packet.

At 440, the quantity of data (e.g., quantity of data packets, quantity of bytes, etc.) received by the user device while receiving the multicast of the content may be associated with an account associated with the user device. For example, the quantity of data received by the user device may be associated by the computing device (e.g., the multicast flow analyzer 119, the multicast flow analyzer 312, or any other computing device) with the account associated with the user device. For example, the computing device may associate or store the calculated or determined quantity of data received by the user device while receiving the multicast of the content with the account associated with the user device. For example, associating the quantity of data may comprise storing the quantity of data in the data record associated with the user device (e.g., based on the user device identifier). For example, associating the quantity of data may comprise storing the quantity of data in another data record associated with the user device (e.g., based on the user device identifier).

For example, the computing device may determine whether to associate the quantity of data with an account associated with the user device. For example, determining whether to associate the quantity of data with the account associated with the user device may be based on the content source. For example, data received by the user device from some content sources may be associated with to the user account while data received by the user device from other content sources may not be associated with the user account. For example, the computing device or any other computing device may comprise a table or listing of content sources. The table or listing may be for content sources for which data will be associated with the account of the user device when content is received from one of those content sources, for content sources for which data will not be associated with the account of the user device when content is received from one of those content sources, or both. The table or listing may comprise multicast source identifiers for each of the content sources. The computing device may compare the multicast source identifier in the data record for the user device to the table or listing of multicast source identifiers to determine if any match exists and to determine whether the quantity of data received by the user device while be associated with the account of the user device. The computing device may then associate or not associate the data received by the user device with the account associated with the user device based on the determination as to whether the quantity of data should be associated with the account associated with the user device.

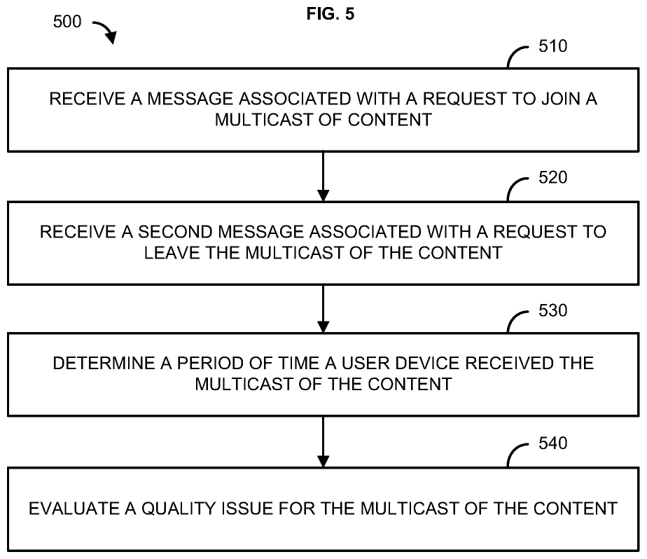

FIG. 5 is a flowchart showing another example method 500 for managing a multicast communication session. The methods described in FIG. 5 may be completed by a computing device (e.g., the multicast flow analyzer 119, multicast flow analyzer 312 or any other computing device). While the example of FIG. 5 describes methods being completed by the computing device, this is for example purposes only, as all or any portion of the method 500 may be completed by any of the computing devices described herein.

At 510, a message associated with a request to join a multicast of content may be received. For example, the message may be received by the computing device (e.g., the multicast flow analyzer 119 or the multicast flow analyzer 312). For example, the message may be received from a second computing device (e.g., a network device 122, such as a local multicast router 306). For example, the message may be received by the computing device from the second computing device via the network 124 or another network. The content may comprise video content, audio content, audio/video content, web content or the like. The message may be an IGMP join request sent via IPv4, a MLD join request sent via IPv6, or another form of request. For example, the message associated with the request to join the multicast of the content may be the same or substantially similar to the message 206, 316.

For example, the message may be a modified version of a request to join the multicast of the content (e.g., the join request 202, 314a-d) received by the second computing device from another computing device (e.g., a user device 130a-c, 310a-d). The message may comprise data from one request to join the multicast of the content (e.g., the join request 202, 314a-d) for one user device to join the multicast of the content or may be a combination of multiple requests to join the multicast of the content (e.g., the join request 202, 314a-d) from multiple user devices to join the multicast of the content for the particular content source.

The message may comprise a header indicating the second computing device as the source of the message and the computing device as the destination of the message. The message may also comprise data (e.g., within a body of the message) comprising a user device identifier, a multicast source identifier, a multicast group identifier, and/or a start time for a user device (e.g., the user device 130a, 310d) associated with the user device identifier to begin receiving the multicast of the content.

The user device identifier may be associated with the user device (e.g., 130a, 310d) and may uniquely identify the user device. For example, the user device identifier may be at least one of a MAC address or a network address. For example, the user device identifier in the message may be merged with other metadata to associate additional user device identifiers with the user device identifier in the message. For example, the additional user device identifiers associated based on other metadata may be at least one of a user account number, a phone number, or a user name.

The multicast source identifier may be associated with a content source (e.g., the content source 102, 302) from which the content is being requested in the request to join the multicast of the content (e.g., the join request 202, 314a-d). The multicast source identifier may uniquely identify the content source. For example, the multicast source identifier may be at least one of a MAC address or a network address. The multicast group identifier may uniquely identify the content (e.g., a particular content item) being requested in the request to join the multicast of the content (e.g., the join request 202, 314a-d). For example, the multicast group identifier may be at least one of a MAC address or a network address. The start time may be a specific time (or time and date) reference (e.g., 12:01 UTC) or may be a timer reference (e.g., a continuous timer reference or clock). For example, the start time may be an indication of a start time associated with the user device receiving the multicast of the content. For example, the start time may be a time stamp appended, inserted, or otherwise included by the second computing device into the message along with other data from the request to join the multicast of the content.

The computing device (e.g., the multicast flow analyzer 119 or the multicast flow analyzer 312) may parse or determine the data within the message. For example, the computing device may determine that the data within the message comprises at least one of one or more user device identifiers, the multicast source identifier, the multicast group identifier, and/or the start time. The computing device may store all or a portion of the received data from the message. For example, the computing device may insert the data into a database, table, or other record-storing system (e.g., a monitor table 322) to monitor when user devices begin receiving the multicast of the content. For example, the computing device may generate and store a separate data record for each user device each time the particular user device requests to join a multicast of a particular content. For example, the generated data record or stored data may comprise the user device identifier, the multicast source identifier, the multicast group identifier, the start time (indicating a start time associated with the user device receiving the multicast of the content), an end time (which may be received at a different point in time and indicating an end time associated with the user device leaving or no longer receiving the multicast of the content), and the quantity of data or data packets received by the user device while receiving the multicast of the content (which may be received at a different point in time). The computing device may also begin receiving the multicast of the content. For example, the computing device may receive data packets of the requested multicast of the content from the content source 102, 302 or the multicast router 120, 304.

At 520, a second message associated with a request to leave the multicast of the content may be received. For example, the second message may be received by the computing device (e.g., the multicast flow analyzer 119 or the multicast flow analyzer 312). For example, the second message may be received from the second computing device (e.g., the network device 122, such as the local multicast router 306). For example, the second message may be received by the computing device from the second computing device via the network 124 or another network. For example, the second message may be an IGMP leave request sent via IPv4, a MLD leave request sent via IPv6, or another form of request. For example, the second message may be the same or substantially similar to the second message 216, 332.

For example, the second message may be a modified version of a request to leave the multicast of the content (e.g., the leave request 212, 330) received by the second computing device from another computing device (e.g., the user devices 130a-c, 310a-d). The second message may comprise data from one request to leave the multicast of the content (e.g., the leave request 212, 330) for one user device or may be a combination of data from multiple requests to leave the multicast of the content (e.g., the leave request 212, 330) from multiple user devices to leave the multicast of the content for the particular content source.

The second message may comprise a header indicating the second computing device as the source of the second message and the computing device as the destination of the second message. The second message may also comprise data (e.g., within a body of the second message) comprising a user device identifier, a multicast source identifier, a multicast group identifier, and/or an end time for a user device (e.g., the user device 130a, 310d) associated with the user device identifier to leave or no longer receive the multicast of the content. The end time may be a specific time (or time and date) reference (e.g., 12:01 UTC) or may be a timer reference (e.g., a continuous timer reference or clock). For example, the end time may be an indication of an end time associated with the user device leaving or no longer receiving the multicast of the content 320. For example, the end time may be a time stamp appended, inserted, or otherwise included by the second computing device into the second message along with other data from the request to leave the multicast of the content.

The computing device may parse or determine the data within the second message. For example, the computing device may determine that the data within the second message comprises at least one of one or more user device identifiers, the multicast source identifier, the multicast group identifier, and/or the end time.

The computing device may store all or a portion of the received data from the second message. For example, the computing device may determine a data record (e.g., in the monitor table 334) that is associated with the (or each) user device identifier in the second message. For example, the computing device may compare the user device identifier in the second message to the user device identifier in each data record to determine if the user device identifier in the second message matches any of the user device identifiers in each data record. Data from the second message may be added to the data record associated with the user device identifier in the second message. For example, the computing device may store the end time from the second message in the associated data record. For example, the user device identifier, the multicast source identifier, and/or the multicast group identifier from the second message may not be stored in the associated data record because that information may already be stored in the associated data record based on information from the message of 510.

At 530, a period of time that the user device (e.g., the user device 130a, 310d) received the multicast of the content may be determined. For example, the period of time the user device received the multicast of the content may be determined by the computing device (e.g., the multicast flow analyzer 119, multicast flow analyzer 312, or any other computing device). Upon receiving the end time for a particular user device (e.g., the user device 130a, 310d) to receive the multicast of the content, the computing device may determine the period of time that the user device received the multicast of the content based on the start time and the end time in the data record associated with the user device (based on the user device identifier). For example, the period of time may be a time span (e.g., Nov. 27, 2021 11:00.03 a.m.-Nov. 27, 2021 11:35.08 a.m.) that the user device received the multicast of the content. For example, the time span may be a time span of the multicast of the content (e.g., 00:00.58-00:35.08) e.g., based on time stamps associated with the multicast of the content.

At 540, a quality issue associated with the multicast of the content may be evaluated. For example, the quality issued may be evaluated by the computing device or any other computing device. For example, quality issues related to jitter, latency, packet drop, packet re-transmit rate, video bitrate variance, and/or out-of-order RTP packet count may be evaluated for the multicast of the content based on an evaluation of the content and for determining if the user device received content with quality issues based on the data record of the user device receiving the requested content.

For example, the computing device may sample packets of the received multicast of the content over a time period and conduct quality control analysis on the packets to evaluate the quality control issues (e.g., jitter, latency, packet drop, packet re-transmit rate, video bitrate variance, and/or out-of-order RTP packet count) within the sample of packets during that time period. The time period can be any amount of time and may be configurable or a set amount of time. For example, the time period may be five seconds. For example, the computing device may sample multiple packets during the time period and evaluate the quality control issues at each packet and any trends for any of the quality control issues as the time passes during that time period.

For example, the computing device may determine that at TO of the content jitter is 20 milliseconds (ms); at T1 jitter is 40 ms; and at T2 jitter is 60 ms for the multicast of the content. For example, the computing device may determine that any jitter in the multicast of content over 0 ms or another jitter threshold signifies a quality issue related to jitter for the multicast of the content. For example, the computing device may determine that a trending increase in jitter over two or more of the time samples signifies a quality issue related to jitter for the multicast of the content. The computing device may store data associated with the quality issue in a database (e.g., the quality analysis database 115). For example, the data may include the type of quality issue (e.g., jitter), the values of jitter determined, and/or the time or time period of the samples evaluated from the multicast of the content that were determined to identify the quality issue.

For example, the computing device may determine that at TO of the content latency is 50 milliseconds (ms); at T1 latency is 150 ms; and at T2 latency is 200 ms in the multicast of the content. For example, the computing device may determine that any latency in the multicast of content over 0 ms or another latency threshold signifies a quality issue related to latency for the multicast of the content. For example, the computing device may determine that a trending increase in latency over two or more of the time samples signifies a quality issue related to latency for the multicast of the content. The computing device may store data associated with the quality issue in a database (e.g., the quality analysis database 115). For example, the data may include the type of quality issue (e.g., latency), the values of latency determined, and/or the time or time period of the samples evaluated from the multicast of the content that were determined to identify the quality issue.

For example, the computing device may determine that at TO of the content packet drop is 0%; at T1 packet drop is 0.5%; and at T2 packet drop is 1% for the multicast of the content. For example, the computing device may determine that any packet drop in the multicast of content over 0% or another packet drop threshold signifies a quality issue related to packet drop for the multicast of the content. For example, the computing device may determine that a trending increase in packet drops over two or more of the time samples signifies a quality issue related to packet drop for the multicast of the content. The computing device may store data associated with the quality issue in a databased (e.g., the quality analysis database 115). For example, the data may include the type of quality issue (e.g., packet drop), the values of packet drop determined, and/or the time or time period of the samples evaluated from the multicast of the content that were determined to identify the quality issue.

For example, the computing device may determine that at TO of the content packet re-transmit rate is 0%; at T1 packet re-transmit rate is 0.5%; and at T2 packet re-transmit rate is 1% for the multicast of the content. For example, the computing device may determine that any packet re-transmit rate in the multicast of content over 0% or another packet re-transmit rate threshold signifies a quality issue related to packet re-transmit rate for the multicast of the content. For example, the computing device may determine that a trending increase in packet re-transmit rate over two or more of the time samples signifies a quality issue related to packet re-transmit rate for the multicast of the content. The computing device may store data associated with the quality issue in a database (e.g., the quality analysis database 115). For example, the data may include the type of quality issue (e.g., packet re-transmit rate), the values of packet re-transmit rate determined, and/or the time or time period of the samples evaluated from the multicast of the content that were determined to identify the quality issue.

For example, the computing device may determine that at TO of the content out-of-order RTP packet count is 0; at T1 out-of-order RTP packet count is 1; and at T2 out-of-order RTP packet count is 2 for the multicast of the content. For example, the computing device may determine that any out-of-order RTP packet count in the multicast of content over 0 or another out-of-order RTP packet count threshold signifies a quality issue related to out-of-order RTP packet count for the multicast of the content. For example, the computing device may determine that a trending increase in out-of-order RTP packet count over two or more of the time samples signifies a quality issue related to out-of-order RTP packet count for the multicast of the content. The computing device may store data associated with the quality issue in a database (e.g., the quality analysis database 115). For example, the data may include the type of quality issue (e.g., out-of-order RTP packet count), the values of out-of-order RTP packet count determined, and/or the time or time period of the samples evaluated from the multicast of the content that were determined to identify the quality issue.

For example, the computing device may determine the bitrate of packets based on an analysis of the MPEG header for the packet. For example, the computing device may determine that at TO of the content the bitrate may be 1900 kbps; at T1 the bitrate is 1200 kbps; and at T2 the bitrate is 900 kbps for the multicast of the content. For example, the computing device may determine that any bitrate in the multicast of content that represents less that a high-definition distribution of the multicast of the content (e.g., less than or less than or equal to 1200 kbps) or another specific bitrate threshold signifies a quality issue related to bitrate for the multicast of the content. For example, the computing device may determine that a trending decrease in bitrate over two or more of the time samples signifies a quality issue related to bitrate for the multicast of the content. The computing device may store data associated with the quality issue in a database (e.g., the quality analysis database 115). For example, the data may include the type of quality issue (e.g., bitrate variance), the values of bitrates determined, and/or the time or time period of the samples evaluated from the multicast of the content that were determined to identify the quality issue.

For example, the computing device may evaluate timing data associated with one or more user devices receiving the multicast of the content to determine if the particular user device was receiving the multicast of the content during the time or time period during which the quality issue was identified in the multicast of the content. For example, the computing device may determine the start time and/or the end time for the user device receiving the multicast of the content from the data record associated with the user device. The computing device may also determine other user devices receiving the multicast of the content during all or a portion of the same time period (between the start time and the end time) as that of the user device from data records associated with those user devices. Based on a comparison of the information from the data records (e.g., the start time and the end time) and the time (e.g., time reference) quality issues were identified in the multicast of the content, the computing device may determine if the any of the user devices were receiving the multicast of the content during the time period or reference of the quality issues identified in the requested content. For example, the computing device can evaluate if the time period or reference of the quality issues falls between the start time and the end time that one or more of the user devices was receiving the multicast of the content.

For multicasts of content where quality issues are identified, for example, the computing device may cause the receipt of the multicast of the content by the user devices 130a-c, 310a-d to change from the current content source 102, 302 to a different content source. For example, the computing device may, based on one or more quality issues, send a message or signal to the content source of the multicast of the content to adjust the bandwidth of the content being multicast. For example, the computing device may send a message to the content source to reduce or lower the bandwidth of the requested content being multicast. For example, the computing device may, based on one or more quality issues, send a message or signal to a network monitoring system to conduct further analysis regarding the multicast and the content being multicast.

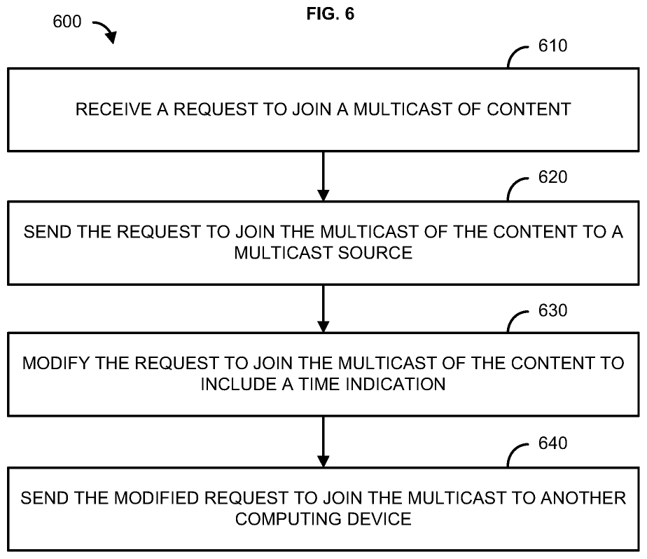

FIG. 6 is a flowchart showing another example method 600 for managing a multicast communication session. The methods described in FIG. 6 may be completed by a computing device (e.g., the network device 122, such as the local multicast router 306, the leaf multicast router, or any other computing device). While the example of FIG. 6 describes methods being completed by the computing device, this is for example purposes only, as all or any portion of the method 600 may be completed by any of the computing devices described herein.

At 610, a request to join a multicast of content may be received. For example, the request to join the multicast of the content may be received by the computing device. For example, the request to join the multicast of the content may be received from a second computing device (e.g., a user device 130a, 310a-d) via the network 124 or another network. For example, the content may be a content item, such as video content, audio content, audio/video content, web content, etc. For example, the request to join the multicast of the content may be an IGMP join request sent via IPv4, an MLD join request sent via IPv6, or another form of request. For example, the request to join the multicast of the content may be the same or substantially similar to the request 202, 314a-d.

The received request to join the multicast of the content may comprise at least one of a user device identifier, a multicast source identifier, and/or a multicast group identifier. The user device identifier may be a unique identifier associated with a second computing device (e.g., the user device) and may uniquely identify the second computing device. For example, the user device identifier may be at least one of a MAC address and/or a network address. For example, the user device identifier in the request may be merged with other metadata to associate additional user device identifiers with the user device identifier in the request. For example, the additional user device identifiers associated based on other metadata may be at least one of a user account number, a phone number, or a user name.

The multicast source identifier may be associated with the source of the multicast of the content (e.g., the content source 102, 302) from which the content (e.g., multicast content) is being requested. The multicast source identifier may uniquely identify the content source. For example, the multicast source identifier may be at least one of a MAC address or a network address. The multicast group identifier may uniquely identify the content (e.g., a particular content item) or group of the multicast being requested and provided by the content source. For example, the multicast group identifier may be at least one of a MAC address or a network address.

The computing device may store all or a portion of the request to join the multicast of the content in memory of the computing device or in another storage device. For example, the computing device may store, from the request to join the multicast of the content, at least one of the user device identifier, the multicast source identifier, and/or the multicast group identifier in a table or other database. Upon later receipt of the multicast of the requested content, the computing device may subsequently reference the stored information to determine the one or more second computing devices (e.g., the user devices 130a-c, 310a-d) that requested to receive the multicast of the content and may send or otherwise transmit that multicast of the content to those particular second computing devices.

At 620, a request to join the multicast of the content may be sent. For example, the request to join the multicast of the content may be sent by the computing device to a source of the multicast content (e.g., the content source 102, 302). For example, the request to join the multicast of the content may be sent directly or indirectly to the content source. For example, the request to join the multicast of the content may be sent by the computing device to the content source via another computing device (e.g. a multicast router 120, 304). For example, the request to join the multicast of the content may be sent by the computing device to the another computing device or the content source via the network 124 or another network. For example, the another computing device may be a remote multicast router communicably positioned further from the user device sending the request to join the multicast of the content than the computing device (e.g., a local multicast router) and closer to the content source. For example, the request to join the multicast of the content may be an IGMP join request sent via IPv4, an MLD join request sent via IPv6, or another form of request.

The request to join the multicast of the content may be the same or different than the received request to join the multicast of the content of 610. For example, the computing device may modify the received request to join the multicast of the content of 610 to create the request to join the multicast of the content that is sent to the content source. For example, upon receiving the received request to join the multicast of the content the computing device may remove the user device identifier from the received request to join the multicast of the content to create the request to join the multicast of the content. For example, the request to join the multicast of the content may comprise at least one of the multicast source identifier or the multicast group identifier. For example, the request to join the multicast of the content may not include the user device identifier associated with the second computing device (e.g., the user device 130a, 310d) requesting to join the multicast of the content.

At 630, the received request to join the multicast of the content may be modified. For example, the received request to join the multicast of the content may be modified to comprise a time indication. For example, the received request to join the multicast of the content may be modified by the computing device (e.g., the network device 122, such as multicast router 306) or any other computing device. For example, the modified request to join the multicast of the content may be an IGMP join request sent via IPv4, a MLD join request sent via IPv6, or another form of request.

For example, the modified request to join the multicast of the content may comprise the received request to join the multicast of the content. For example, the modified request to join the multicast of the content may comprise all or a portion of the received request to join the multicast of the content or the data in the received request to join the multicast of the content. For example, the modified request to join the multicast of the content may comprise at least one of the user device identifier, the multicast source identifier, or the multicast group identifier from the received request to join the multicast of the content. The modified request to join the multicast of the content may also comprise a start time for the second computing device (e.g., the user device 130a, 310a-d) to begin receiving the content. For example, the computing device may add, insert, append, or otherwise include the start time (generated by the computing device) with all or a portion of the received request to join the multicast of the content, to create or generate the modified request to join the multicast of the content. The start time may be a specific time (or time and date) reference (e.g., 12:01 UTC) or may be a timer reference (e.g., a continuous timer reference or clock). For example, the start time may be an indication of a start time associated with the second computing device receiving the multicast of the content. For example, the computing device may comprise a clock or timer from which the computing device determines the start time to include in the modified request to join the multicast of the content. For example, the start time may be a time stamp appended, inserted, or otherwise included in the modified request to join the multicast of the content.

For example, the computing device may repackage the received request to join the multicast of the content to create the modified request to join the multicast of the content. For example, the computing device may encapsulate the start time, from the computing device, with all or the portion of the received request to join the multicast of the content to create the modified request to join the multicast of the content. For example, the encapsulated modified request to join the multicast of the content may comprise a header that identifies the source of the modified request to join the multicast of the content as the computing device and the destination as the other computing device (e.g., the multicast flow analyzer 119 or the multicast flow analyzer 312) and comprises as data within the body of the modified request to join the multicast of the content the user device identifier, the multicast source identifier, the multicast group identifier, and/or the start time as data within the modified request to join the multicast of the content.

At 640, the modified request to join the multicast of the content may be sent. For example, the modified request to join the multicast of the content may be sent by the computing device (e.g., the network device 122, such as the local multicast router 306) to a third computing device (e.g., the multicast flow analyzer 119 or the multicast flow analyzer 312). For example, the modified request to join the multicast of the content may be sent from the computing device to the third computing device via the network 124 or another network. For example, the modified request to join the multicast of the content may be sent directly or indirectly from the computing device to the third computing device.

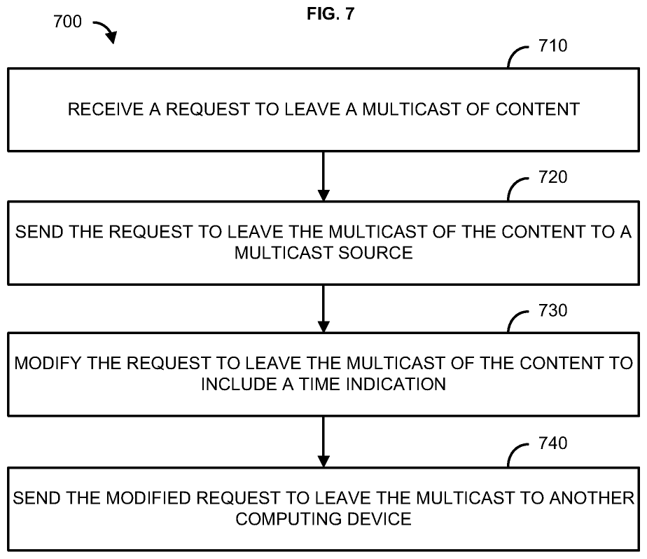

FIG. 7 is a flowchart showing another example method 700 for managing a multicast communication session. The methods described in FIG. 7 may be completed by a computing device (e.g., the network device 122, such as the local multicast router 306, the leaf multicast router, or any other computing device). While the example of FIG. 7 describes methods being completed by the computing device, this is for example purposes only, as all or any portion of the method 700 may be completed by any of the computing devices described herein.

At 710, a request to leave a multicast of the content may be received. For example, the request to leave the multicast of the content may be received by the computing device. For example, the request to leave the multicast of the content may be received from a second computing device (e.g., a user device 130a, 310d) via the network 124 or another network. For example, the content may be a content item, such as video content, audio content, audio/video content, web content, etc. For example, the request to leave the multicast of the content may be an IGMP leave request sent via IPv4, an MLD leave request sent via IPv6, or another form of message. For example, the request to leave the multicast of the content may be the same or substantially similar to the request 212, 330.

The received request to leave the multicast of the content may comprise at least one of a user device identifier, a multicast source identifier, and/or a multicast group identifier. The user device identifier may be a unique identifier associated with the second computing device (e.g., the user device) and may uniquely identify the second computing device. For example, the user device identifier may be at least one of a MAC address and/or a network address. For example, the user device identifier in the request may be merged with other metadata to associate additional user device identifiers with the user device identifier in the request. For example, the additional user device identifiers associated based on other metadata may be at least one of a user account number, a phone number, or a user name.

The multicast source identifier may be associated with the source of the multicast of the content (e.g., the content source 102, 302) from which the content (e.g., multicast content) is being requested. The multicast source identifier may uniquely identify the content source. For example, the multicast source identifier may be at least one of a MAC address or a network address. The multicast group identifier may uniquely identify the content (e.g., a particular content item) or group of the multicast being requested and provided by the content source. For example, the multicast group identifier may be at least one of a MAC address or a network address.

The computing device may store all or a portion of the received request to leave the multicast of the content in memory of the computing device or in another storage device. For example, the computing device may store, from the received request to leave the multicast of the content, at least one of the user device identifier, the multicast source identifier, and/or the multicast group identifier in a table or other database. For example, the computing device may identify a prior data entry or record associated with the user device based on a comparison of the user device identifier in the received request to leave the multicast of the content and the one or more entries or records containing stored user device identifiers. For example, upon identifying a record or entry with a matching user device identifier, the computing device may store data associated with the received request to leave the multicast of the content in that particular record or entry. For example, based on receiving the request to leave the multicast of the content, the computing device may discontinue sending or transmitting the request content to the second computing device.

At 720, a request to leave the multicast of the content may be sent. For example, the request to leave the multicast of the content may be sent by the computing device to a source of the multicast content (e.g., the content source 102, 302) or another multicast router (e.g., the multicast router 120, 304). For example, the request to leave the multicast of the content may be sent by the computing device to the content source via another computing device (e.g. a multicast router 120, 304). For example, the request to leave the multicast of the content may be sent by the computing device to the another computing device or the content source via the network 124 or another network. For example, the another computing device may be a remote multicast router communicably positioned further from the user device sending the request to leave the multicast of the content than the computing device (e.g., a local multicast router 306) and closer to the content source (e.g., content source 102, 302). For example, the request to leave the multicast of the content may be an IGMP leave request sent via IPv4, an MLD leave request sent via IPv6, or another form of leave request.

The request to leave the multicast of the content may be the same or different than the received request to leave the multicast of the content of 710. For example, the computing device may modify the received request to leave the multicast of the content of 710 to create the request to leave the multicast of the content that is sent to the other computing device and/or the content source. For example, upon receiving the received request to leave the multicast of the content the computing device may remove the user device identifier from the received request to leave the multicast of the content to create the request to leave the multicast of the content. For example, the request to leave the multicast of the content may comprise at least one of the multicast source identifier or the multicast group identifier. For example, the request to leave the multicast of the content may not include the user device identifier associated with the second computing device (e.g., the user device 130a, 310d) requesting to leave the multicast of the content.

At 730, the received request to leave the multicast of the content may be modified. For example, the received request to leave the multicast of the content may be modified to comprise a time indication. For example, the received request to leave the multicast of the content may be modified by the computing device (e.g., the network device 122, such as multicast router 306) or any other computing device. For example, the modified request to leave the multicast of the content may be an IGMP leave request sent via IPv4, a MLD leave request sent via IPv6, or another form of leave request.

For example, the modified request to leave the multicast of the content may comprise the received request to leave the multicast of the content. For example, the modified request to leave the multicast of the content may comprise all or a portion of the received request to leave the multicast of the content or the data in the received request to leave the multicast of the content. For example, the modified request to leave the multicast of the content may comprise at least one of the user device identifier, the multicast source identifier, or the multicast group identifier from the received request to leave the multicast of the content. The modified request to leave the multicast of the content may also comprise an end time for the second computing device (e.g., the user device 130a, 310d) to leave or stop receiving the multicast of the content. For example, the computing device may add, insert, append, or otherwise include the end time (generated by the computing device) with all or a portion of the received request to leave the multicast of the content, to create or generate the modified request to leave the multicast of the content. The end time may be a specific time (or time and date) reference (e.g., 12:01 UTC) or may be a timer reference (e.g., a continuous timer reference or clock). For example, the end time may be an indication of an end time associated with the second computing device leaving or no longer receiving the multicast of the content. For example, the computing device may comprise a clock or timer from which the computing device determines the end time to include in the modified request to leave the multicast of the content. For example, the end time may be a time stamp appended, inserted, or otherwise included in the modified request to leave the multicast of the content.

For example, the computing device may repackage the received request to leave the multicast of the content to create the modified request to leave the multicast of the content. For example, the computing device may encapsulate the end time, from the computing device, with all or the portion of the received request to leave the multicast of the content to create the modified request to leave the multicast of the content. For example, the encapsulated modified request to leave the multicast of the content may comprise a header that identifies the source of the modified request to leave the multicast of the content as the computing device and the destination as the third computing device (e.g., the multicast flow analyzer 119 or the multicast flow analyzer 312) and comprises as data within the body of the modified request to leave the multicast of the content the user device identifier, the multicast source identifier, the multicast group identifier, and/or the end time as data within the modified request to leave the multicast of the content.

At 740, the modified request to leave the multicast of the content may be sent. For example, the modified request to leave the multicast of the content may be sent by the computing device (e.g., the network device 122, such as the local multicast router 306) to the third computing device (e.g., the multicast flow analyzer 119 or the multicast flow analyzer 312). For example, the modified request to leave the multicast of the content may be sent from the computing device to the third computing device via the network 124 or another network. For example, the modified request to leave the multicast of the content may be sent directly or indirectly to the third computing device.

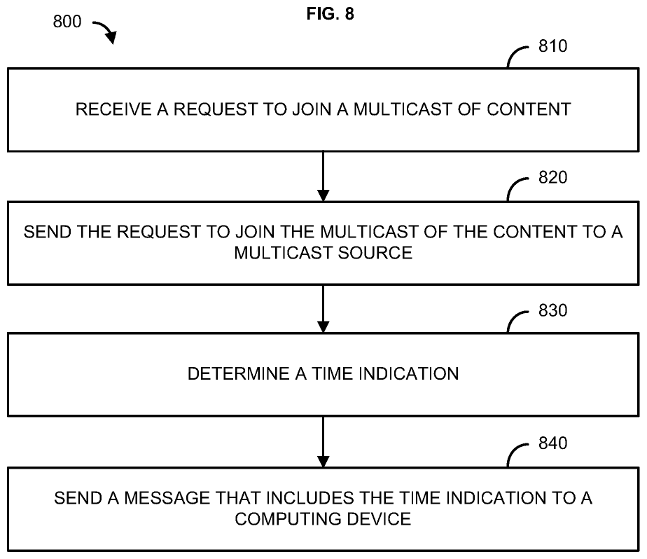

FIG. 8 is a flowchart showing another example method 800 for managing a multicast communication session. The methods described in FIG. 8 may be completed by a computing device (e.g., the network device 122, such as the local multicast router 306, the leaf multicast router, or any other computing device). While the example of FIG. 8 describes methods being completed by the computing device, this is for example purposes only, as all or any portion of the method 600 may be completed by any of the computing devices described herein.

At 810, a request to join a multicast of content may be received. For example, the request to join the multicast of the content may be received by the computing device. For example, the request to join the multicast of the content may be received from a second computing device (e.g., a user device 130a, 310a-d) via the network 124 or another network. For example, the content may be a content item, such as video content, audio content, audio/video content, web content, etc. For example, the request to join the multicast of the content may be an IGMP join request sent via IPv4, an MLD join request sent via IPv6, or another form of request. For example, the request to join the multicast of the content may be the same or substantially similar to the request 202, 314a-d.

The received request to join the multicast of the content may comprise at least one of a user device identifier, a multicast source identifier, and/or a multicast group identifier. The user device identifier may be a unique identifier associated with the second computing device (e.g., the user device 130a, 310a-d) and may uniquely identify the second computing device. For example, the user device identifier may be at least one of a MAC address and/or a network address. For example, the user device identifier in the request may be merged with other metadata to associate additional user device identifiers with the user device identifier in the request. For example, the additional user device identifiers associated based on other metadata may be at least one of a user account number, a phone number, or a user name.

The multicast source identifier may be associated with the source of the multicast of the content (e.g., the content source 102, 302) from which the content (e.g., multicast content) is being requested. The multicast source identifier may uniquely identify the content source. For example, the multicast source identifier may be at least one of a MAC address or a network address. The multicast group identifier may uniquely identify the content (e.g., a particular content item) or group of the multicast being requested and provided by the content source. For example, the multicast group identifier may be at least one of a MAC address or a network address.

The computing device may store all or a portion of the request to join the multicast of the content in memory of the computing device or in another storage device. For example, the computing device may store, from the request to join the multicast of the content, at least one of the user device identifier, the multicast source identifier, and/or the multicast group identifier in a table or other database. Upon later receipt of the multicast of the requested content, the computing device may subsequently reference the stored information to determine the one or more second computing devices (e.g., the user devices 130a-c, 310a-d) that requested to receive the multicast of the content and may send or otherwise transmit that multicast of the content to those particular second computing devices.

At 820, a request to join the multicast of the content may be sent. For example, the request to join the multicast of the content may be sent by the computing device to a source of the multicast content (e.g., the content source 102, 302). For example, the request to join the multicast of the content may be sent directly or indirectly to the content source. For example, the request to join the multicast of the content may be sent by the computing device to the content source via another computing device (e.g. a multicast router 120, 304). For example, the request to join the multicast of the content may be sent by the computing device to the another computing device or the content source via the network 124 or another network. For example, the another computing device may be a remote multicast router communicably positioned further from the user device sending the request to join the multicast of the content than the computing device (e.g., a local multicast router) and closer to the content source. For example, the request to join the multicast of the content may be an IGMP join request sent via IPv4, an MLD join request sent via IPv6, or another form of request.

The request to join the multicast of the content may be the same or different than the received request to join the multicast of the content of 810. For example, the computing device may modify the received request to join the multicast of the content of 810 to create the request to join the multicast of the content that is sent to the content source. For example, upon receiving the received request to join the multicast of the content the computing device may remove the user device identifier from the received request to join the multicast of the content to create the request to join the multicast of the content. For example, the request to join the multicast of the content may comprise at least one of the multicast source identifier or the multicast group identifier. For example, the request to join the multicast of the content may not include the user device identifier associated with the second computing device (e.g., the user device 130a, 310d) requesting to join the multicast of the content.

At 830, a time indication may be determined. For example, the time indication may be determined by the computing device (e.g., the network device 122, such as the multicast router 306) or any other computing device. For example, the time indication may be a specific time (or time and date) reference (e.g., 12:01 UTC) or may be a timer reference (e.g., a continuous timer reference or clock). For example, the time indication may be an indication of a start time associated with the second computing device receiving the multicast of the content. For example, the computing device may comprise a clock or timer from which the computing device determines the time indication. For example, the time indication may be a time stamp.

For example, the time indication may indicate the time the second computing device (e.g., the user device 130a, 310d) requested to join the multicast of the content. The computing device may determine the time the second computing device requested to join the multicast of the content from the received request to join the multicast of the content. For example, the time indication may indicate the time the computing device received the request to join the multicast of the content from the second computing device. The computing device may determine the time the computing device received the request to join the multicast of the content from the clock or timer and/or data in a cache of the computing device. For example, the time indication may indicate a start time (e.g., an exact start time or estimated start time) that the second computing device begins receiving the multicast of the content. For example, the computing device may estimate the start time the second computing device begins receiving the multicast of the content based on the current time and an average, estimated, predetermined or preset amount of time that occurs between the time the computing device sends the request to join the multicast of the content at 820 and the time a second computing device will typically begin receiving the multicast of the content.

At 840, a message comprising the time indication (e.g., start time indication) may be sent to a third computing device. For example, the message may be generated by the computing device (e.g., the network device 122, such as multicast router 306). For example, the message may be sent by the computing device or any other computing device and may be sent to the third computing device (e.g., the multicast flow analyzer 119 or the multicast flow analyzer 312). For example, the message may be sent from the computing device (e.g., the network device 122, such as multicast router 306) to the third computing device (e.g., the multicast flow analyzer 119 or the multicast flow analyzer 312) via the network 124 or another network. For example, the message may be sent directly or indirectly from the computing device to the third computing device.

For example, the message may comprise all or any portion of the received request to join the multicast of the content or the data in the received request to join the multicast of the content. For example, the message may comprise at least one of the user device identifier, the multicast source identifier, or the multicast group identifier from the received request to join the multicast of the content. The message may also comprise, as the time indication, a start time for the second computing device (e.g., the user device 130a, 310a-d) to begin receiving the content. For example, the computing device may add, insert, append, or otherwise include the time indication with all or a portion of the received request to join the multicast of the content, to create or generate the message. For example, the time indication may be a time stamp appended, inserted, or otherwise included in the message. For example, the computing device may encapsulate the time indication with all or the portion of the received request to join the multicast of the content to create the message. For example, the encapsulated message may comprise a header that identifies the source of the message as the computing device and the destination as the third computing device (e.g., the multicast flow analyzer 119 or the multicast flow analyzer 312) and comprises as data within the body of the message the user device identifier, the multicast source identifier, the multicast group identifier, and/or the time indication. For example, the message may be or comprise an IGMP join request sent via IPv4, a MLD join request sent via IPv6, or another form of message.

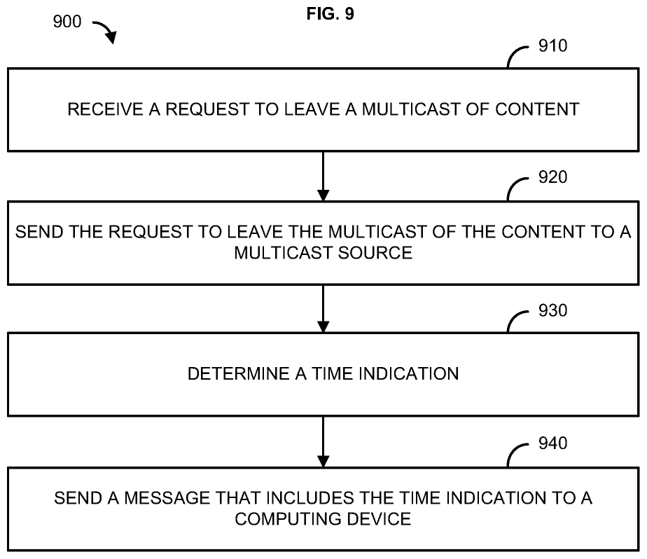

FIG. 9 is a flowchart showing another example method 900 for managing a multicast communication session. The methods described in FIG. 9 may be completed by a computing device (e.g., the network device 122, such as the local multicast router 306, the leaf multicast router, or any other computing device). While the example of FIG. 9 describes methods being completed by the computing device, this is for example purposes only, as all or any portion of the method 900 may be completed by any of the computing devices described herein.

At 910, a request to leave a multicast of the content may be received. For example, the request to leave the multicast of the content may be received by the computing device (e.g., the network device 122, such as the local multicast router 306, the leaf multicast router, or any other computing device). For example, the request to leave the multicast of the content may be received from a second computing device (e.g., a user device 130a, 310d) via the network 124 or another network. For example, the content may be a content item, such as video content, audio content, audio/video content, web content, etc. For example, the request to leave the multicast of the content may be an IGMP leave request sent via IPv4, an MLD leave request sent via IPv6, or another form of message. For example, the request to leave the multicast of the content may be the same or substantially similar to the request 212, 330.

The received request to leave the multicast of the content may comprise at least one of a user device identifier, a multicast source identifier, and/or a multicast group identifier. The user device identifier may be a unique identifier associated with the second computing device (e.g., the user device 130a, 310d) and may uniquely identify the second computing device. For example, the user device identifier may be at least one of a MAC address and/or a network address. For example, the user device identifier in the request may be merged with other metadata to associate additional user device identifiers with the user device identifier in the request. For example, the additional user device identifiers associated based on other metadata may be at least one of a user account number, a phone number, or a user name.

The multicast source identifier may be associated with the source of the multicast of the content (e.g., the content source 102, 302) from which the content (e.g., multicast content) is being requested. The multicast source identifier may uniquely identify the content source. For example, the multicast source identifier may be at least one of a MAC address or a network address. The multicast group identifier may uniquely identify the content (e.g., a particular content item) or group of the multicast being requested and provided by the content source. For example, the multicast group identifier may be at least one of a MAC address or a network address.

The computing device may store all or a portion of the received request to leave the multicast of the content in memory of the computing device or in another storage device. For example, the computing device may store, from the received request to leave the multicast of the content, at least one of the user device identifier, the multicast source identifier, and/or the multicast group identifier in a table or other database. For example, the computing device may identify a prior data entry or record associated with the user device based on a comparison of the user device identifier in the received request to leave the multicast of the content and the one or more entries or records containing stored user device identifiers. For example, upon identifying a record or entry with a matching user device identifier, the computing device may store data associated with the received request to leave the multicast of the content in that particular record or entry. For example, based on receiving the request to leave the multicast of the content, the computing device may discontinue sending or transmitting the request content to the second computing device.

At 920, a request to leave the multicast of the content may be sent. For example, the request to leave the multicast of the content may be sent by the computing device to a multicast source of the multicast content (e.g., the content source 102, 302) or another multicast router (e.g., the multicast router 120, 304). For example, the request to leave the multicast of the content may be sent by the computing device to the content source via another computing device (e.g. a multicast router 120, 304). For example, the request to leave the multicast of the content may be sent by the computing device to the another computing device or the content source via the network 124 or another network. For example, the another computing device may be a remote multicast router communicably positioned further from the user device sending the request to leave the multicast of the content than the computing device (e.g., a local multicast router 306) and closer to the content source (e.g., content source 102, 302). For example, the request to leave the multicast of the content may be or comprise an IGMP leave request sent via IPv4, an MLD leave request sent via IPv6, or another form of leave request.

The request to leave the multicast of the content may be the same or different than the received request to leave the multicast of the content of 910. For example, the computing device may modify the received request to leave the multicast of the content of 910 to create the request to leave the multicast of the content that is sent to the other computing device and/or the content source. For example, upon receiving the received request to leave the multicast of the content the computing device may remove the user device identifier from the received request to leave the multicast of the content to create the request to leave the multicast of the content. For example, the request to leave the multicast of the content may comprise at least one of the multicast source identifier or the multicast group identifier. For example, the request to leave the multicast of the content may not include the user device identifier associated with the second computing device (e.g., the user device 130a, 310d) requesting to leave the multicast of the content.

At 930, a time indication may be determined. For example, the time indication may be determined by the computing device (e.g., the network device 122, such as the multicast router 306) or any other computing device. For example, the time indication may be a specific time (or time and date) reference (e.g., 12:01 UTC) or may be a timer reference (e.g., a continuous timer reference or clock). For example, the time indication may be an indication of an end time associated with the second computing device no longer receiving the multicast of the content. For example, the computing device may comprise a clock or timer from which the computing device determines the time indication. For example, the time indication may be a time stamp.

For example, the time indication may indicate the time the second computing device (e.g., the user device 130a, 310d) requested to leave the multicast of the content. The computing device may determine the time the second computing device requested to leave the multicast of the content from the received request to leave the multicast of the content. For example, the time indication may indicate the time the computing device received the request to leave the multicast of the content from the second computing device. The computing device may determine the time the computing device received the request to leave the multicast of the content from the clock or timer and/or data in a cache of the computing device. For example, the time indication may indicate an end time (e.g., an exact end time or estimated end time) that the second computing device stops receiving the multicast of the content. For example, the computing device may estimate the end time the second computing device stops receiving the multicast of the content based on the current time and an average, estimated, predetermined or preset amount of time that occurs between the time the computing device sends the request to leave the multicast of the content at 920 and the time a second computing device will typically stop receiving the multicast of the content.

At 940, a message comprising the time indication (e.g., end time indication) may be sent to a third computing device (e.g., the multicast flow analyzer 119 or the multicast flow analyzer 312). For example, the message may be generated by the computing device (e.g., the network device 122, such as multicast router 306). For example, the message may be sent by the computing device or any other computing device and may be sent to the third computing device (e.g., the multicast flow analyzer 119 or the multicast flow analyzer 312). For example, the message may be sent from the computing device (e.g., the network device 122, such as multicast router 306) to the third computing device (e.g., the multicast flow analyzer 119 or the multicast flow analyzer 312) via the network 124 or another network. For example, the message may be sent directly or indirectly from the computing device to the third computing device.

For example, the message may comprise all or any portion of the received request to leave the multicast of the content or the data in the received request to leave the multicast of the content. For example, the message may comprise at least one of the user device identifier, the multicast source identifier, or the multicast group identifier from the received request to leave the multicast of the content. The message may also comprise, as the time indication, an end time for the second computing device (e.g., the user device 130a, 310a-d) no longer receiving the content. For example, the computing device may add, insert, append, or otherwise include the time indication with all or a portion of the received request to leave the multicast of the content, to create or generate the message. For example, the time indication may be a time stamp appended, inserted, or otherwise included in the message. For example, the computing device may encapsulate the time indication with all or the portion of the received request to leave the multicast of the content to create the message. For example, the encapsulated message may comprise a header that identifies the source of the message as the computing device and the destination as the third computing device (e.g., the multicast flow analyzer 119 or the multicast flow analyzer 312) and comprises as data within the body of the message the user device identifier, the multicast source identifier, the multicast group identifier, and/or the time indication. For example, the message may be or comprise an IGMP leave request sent via IPv4, a MLD leave request sent via IPv6, or another form of message. For example, the message of 840 and the message of 940 may enable a determination of a total quantity of data received by the second computing device (e.g., the user device 130a, 310a-d) for the multicast of the content.

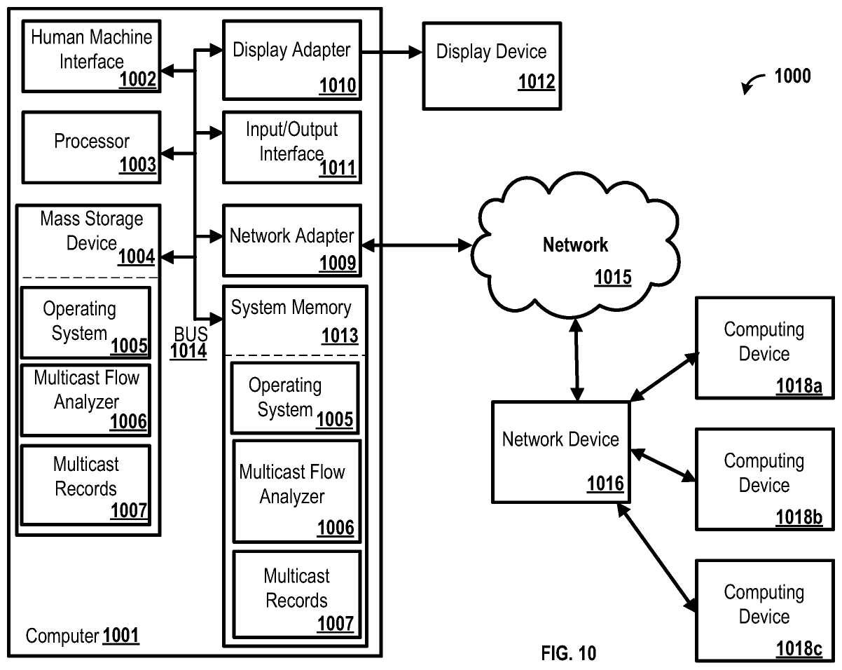

FIG. 10 shows a system 1000 for implementing management of a multicast communication session. Any one or more of the network device 122, multicast flow analyzer 119, user devices 130a-c, multicast router 120, and content source 102 of FIG. 1 and the local multicast router 306, multicast flow analyzer 312, content source 302, multicast router 304, and user devices 310a-d of FIGS. 3A-B may be a computer 1001 as shown in FIG. 10.

The computer 1001 may comprise one or more processors 1002, a system memory 1013, and a bus 1014 that couples various components of the computer 1001 including the one or more processors 1003 to the system memory 1013. In the case of multiple processors 1003, the computer 1001 may utilize parallel computing.

The bus 1014 may comprise one or more of several possible types of bus structures, such as a memory bus, memory controller, a peripheral bus, an accelerated graphics port, and a processor or local bus using any of a variety of bus architectures.

The computer 1001 may operate on and/or comprise a variety of computer-readable media (e.g., non-transitory). Computer-readable media may be any available media that is accessible by the computer 1001 and includes, non-transitory, volatile and/or non-volatile media, and removable and non-removable media. The system memory 1013 has computer-readable media in the form of volatile memory, such as random access memory (RAM), and/or non-volatile memory, such as read-only memory (ROM). The system memory 1013 may store data such as multicast record data 1007 and/or program modules such as operating system 1005 and multicast flow analyzer 1006 that are accessible to and/or are operated on by the one or more processors 1003.

The computer 1001 may also comprise other removable/non-removable, volatile/non-volatile computer storage media. The mass storage device 1004 may provide non-volatile storage of computer code, computer-readable instructions, data structures, program modules, and other data for the computer 1001. The mass storage device 1004 may be a hard disk, a removable magnetic disk, a removable optical disk, magnetic cassettes or other magnetic storage devices, flash memory cards, CD-ROM, digital versatile disks (DVD) or other optical storage, RAM, ROM, electrically erasable programmable read-only memory (EEPROM), and the like.

Any number of program modules may be stored on the mass storage device 1004. An operating system 1005 and multicast flow analyzer software 1006 may be stored on the mass storage device 1004. One or more of the operating system 1005 and multicast flow analyzer software 1006 (or some combination thereof) may comprise program modules and the multicast flow analyzer software 1006. Multicast records data 1007 may also be stored on the mass storage device 1004.

Multicast records data 1007 may comprise information associated with a multicast of content. For example, the information associated with a multicast of content may comprise one or more of the multicast source identifier, the multicast group identifier, one or more bit rates for the multicast of the content, time entries associated with the sending of the multicast of the content, packet identifiers or numbers associated with particular time entries, data amounts associated with particular time entries, and time periods or time references for quality issues associated with the multicast of the content. Multicast records data 1007 may also comprise data records or entries for each computing device 1018a-c (e.g., user devices) receiving the multicast of the content and each time the respective computing device 1018a-c receives the multicast of the content. The data records or entries may comprise a user device identifier, the multicast source identifier, the multicast group identifier, the time the computing device 1018a-c joined the particular multicast of the content, the time the computing device 1018a-c left or stopped receiving the multicast of the content, the number of packets the computing device 1018a-c received while receiving the multicast of the content, and/or the quantity of data received by the computing device 1018a-c while receiving the multicast of the content. The multicast records data 1007 may also comprise data associated with which content sources (e.g., the multicast content sources), based on the multicast source identifier or multicast group identifier, for which data will be applied to an account associated with the computing device 1018a-c and/or will not be applied to an account associated with the computing device 1018a-c. The multicast records 1007 may be stored in any of one or more databases known in the art. The databases may be centralized or distributed across multiple locations within the network 1015.

A user may enter commands and information into the computer 1001 via an input device (not shown). Such input devices include, but are not limited to, a keyboard, pointing device (e.g., a computer mouse or remote control), a microphone, a joystick, a scanner, tactile input devices such as gloves, and other body coverings, a motion sensor, and the like These and other input devices may be connected to the one or more processors 1003 via a human-machine interface 1002 that is coupled to the bus 1014, but may be connected by other interface and bus structures, such as a parallel port, game port, an IEEE 1394 Port (also known as a Firewire port), a serial port, network adapter 1009, and/or a universal serial bus (USB).

A display device 1012 may also be connected to the bus 1014 via an interface, such as a display adapter 1010. It is contemplated that the computer 1001 may have more than one display adapter 1010 and the computer 1001 may have more than one display device 1012. A display device 1012 may be a monitor, an LCD (Liquid Crystal Display), a light-emitting diode (LED) display, a television, smart lens, smart glass, and/or a projector. In addition to the display device 1012, other output peripheral devices may comprise components such as speakers (not shown) and a printer (not shown) which may be connected to the computer 1001 via Input/Output Interface 1011. Any step and/or result of the methods may be output (or caused to be output) in any form to an output device. Such output may be any form of visual representation, including, but not limited to, textual, graphical, animation, audio, tactile, and the like. The display 1012 and computer 1001 may be part of one device, or separate devices.

The computer 1001 may operate in a networked environment using logical connections to one or more computing devices 1018a-c. Each computing device 1018a-c may be user device, a client device, a personal computer, computing station, workstation, portable computer, laptop computer, mobile phone, tablet device, smartphone, smartwatch, activity tracker, smart apparel, smart accessory, security and/or monitoring device, a mobile device, a game system, a content output device, an IoT device, a server, a router, a network computer, a peer device, edge device or other common network nodes, and so on. Logical connections between the computer 1001 and each computing device 1018a-c may be made via a network 1015, such as a local area network (LAN) and/or a general wide area network (WAN) and one or more network devices 1016 (e.g., a router, an edge device, an access point or other common network nodes). Such network connections may be through a network adapter 1009. A network adapter 1009 may be implemented in both wired and wireless environments. Such networking environments are conventional and commonplace in dwellings, offices, enterprise-wide computer networks, intranets, and the Internet.

Application programs and other executable program components such as the operating system 1005 and the multicast flow analyzer 1006 are shown herein as discrete blocks, although it is recognized that such programs and components may reside at various times in different storage components of the computing device 1001, and are executed by the one or more processors 1003 of the computer 1001. An implementation of the multicast flow analyzer software 1006 may be stored on or sent across some form of computer-readable media. Any of the disclosed methods may be performed by processor-executable instructions embodied on computer-readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
receiving, by a computing device, a message associated with a request to join a multicast of content, wherein the message comprises a user device identifier associated with a user device;
receiving a second message associated with a request to leave the multicast of the content, wherein the second message comprises the user device identifier;
determining, based on the message and the second message, a quantity of data received by the user device from the multicast of the content; and
associating the quantity of data with an account associated with the user device.

2. The method of claim 1, wherein the message further comprises an indication of a start time associated with the user device receiving the multicast of the content, wherein the second message further comprises an indication of an end time associated with the user device leaving the multicast of the content, and wherein determining the quantity of data received by the user device from the multicast of the content is further based on the start time and the end time.

3. The method of claim 1, wherein the user device identifier comprises at least one of a MAC address, a network address, a user account number, a phone number, or a user name.

4. The method of claim 1, further comprising storing at least a portion of data from the message, wherein the data from the message comprises at least one of the user device identifier, a multicast source identifier, a multicast group identifier, or a start time for the user device receiving the multicast of the content.

5. The method of claim 1, further comprising:
generating, based on receiving the message, a record for the user device comprising at least a portion of data in the message; and
modifying, based on receiving the second message, the record for the user device to include at least a portion of data in the second message.

6. The method of claim 1, wherein the message further comprises an indication of a start time associated with the user device receiving the multicast of the content, wherein the second message further comprises an indication of an end time associated with the user device leaving the multicast of the content, and wherein the method further comprises:
determining, based on the start time and the end time, a period of time the user device received the multicast of the content; and
evaluating, based on the period of time, a quality issue for the multicast of content at the user device.

7. The method of claim 1, wherein the message further comprises an indication of a start time associated with the user device receiving the multicast of the content, wherein the second message further comprises an indication of an end time associated with the user device leaving the multicast of the content, and wherein the method further comprises:
receiving a data rate for the multicast of the content,
wherein determining the quantity of data received by the user device comprises determining, based on the data rate, the start time, and the end time, the quantity of data received by the user device from the multicast of the content.

8. The method of claim 1, wherein the quantity of data comprises at least one of a quantity of data packets or a quantity of bytes.

9. A method comprising;
receiving, by a computing device, a message associated with a request to join a multicast of content, wherein the message comprises a user device identifier associated with a user device and a start time associated with the user device receiving the multicast of the content;
receiving a second message associated with a request to leave the multicast of the content, wherein the second message comprises the user device identifier and an end time associated with the user device leaving the multicast of the content;
determining, based on the start time and the end time, a period of time the user device received the multicast of content; and
evaluating, based on the period of time, a quality issue for the multicast of content at the user device.

10. The method of claim 9, wherein evaluating the quality issue for the multicast of content comprises:
receiving, by the computing device, at least a portion of the multicast of content;
determining, based on the at least the portion of the multicast of content, the quality issue for the multicast of content and a time reference for the quality issue; and
determining, based on the time reference and the period of time, that the user device received the multicast of content with the quality issue.

11. The method of claim 9, further comprising:
receiving a data rate for the multicast of content; and
determining, based on the data rate, the request, and the second request, a quantity of data received by the user device from the multicast of the content.

12. The method of claim 10, further comprising applying the quantity of data to an account associated with the user device.

13. The method of claim 9, further comprising:
generating, based on receiving the message, a record for the user device comprising at least a portion of data in the message; and
modifying, based on receiving the second message, the record for the user device to include at least a portion of data in the second message.

14. The method of claim 9, wherein the message further comprises at least one of a multicast source identifier or a multicast group identifier.

15. The method of claim 9, wherein the second message further comprises at least one of a multicast source identifier or a multicast group identifier.

16. A method comprising;
receiving, from a user device and by a computing device, a request to join a multicast of content;
sending, to a content source, at least a portion of the request to join the multicast of the content;
determining, based on the request to join the multicast of the content, a time indication;
sending, to a second computing device, a message comprising the time indication;
receiving a request to leave the multicast of the content;
sending, to the second computing device, a second message comprising a second time indication, wherein the second time indication is based on the request to leave the multicast of the content,
wherein the message and the second message enable a determination of a total quantity of data received by the user device for the multicast of the content.

17. The method of claim 16, wherein the message further comprises at least a second portion of the request to join the multicast of the content and wherein the second message further comprises at least a portion of the request to leave the multicast of the content.

18. The method of claim 16, further comprising:
modifying the request to join the multicast of the content to remove at least a second portion of the request to join the multicast of the content,
wherein sending the at least the portion of the request to join the multicast of the content comprises sending, to the content source, the modified request to join the multicast of the content.

19. The method of claim 16, wherein the time indication is associated with a start time for the user device receiving the multicast of the content and wherein the second time indication is associated with a leave time for the user device no longer receiving the multicast of the content.

20. The method of claim 16, further comprising encapsulating the request to join the multicast of the content and the time indication into the message.
